(19) United States
(12) Patent Application Publication
(10) Pub. No.: US 2026/0238087 A1
(43) Pub. Date: Aug. 13, 2026

(54) MOTOR AND AIRCRAFT

(71) Applicant: Nidec Corporation, Kyoto (JP)

(72) Inventor: Atsushi YAWATA, Muko-shi (JP)

(21) Appl. No.: 18/705,743

(22) PCT Filed: Nov. 7, 2022
(86) PCT No.: PCT/JP2022/041411

§ 371 Date: Apr. 8, 2026

(30) Foreign Application Priority Data
Nov. 5, 2021 (JP) 2021-181527
Nov. 5, 2021 (JP) 2021-181528
Nov. 5, 2021 (JP) 2021-181529

(51) Int. Cl. H02K 9/22; B64D 27/34; B64D 33/08; H02K 5/173; H02K 7/08; H02K 9/19; H02K 21/22

(52) U.S. Cl. CPC H02K 9/225; B64D 27/34; B64D 33/08; H02K 5/1735; H02K 7/085; H02K 9/19; H02K 21/22

(57) ABSTRACT

A motor includes a rotor, a stator, and a flow pipe. The rotor is rotatable about a central axis extending in an axial direction. The stator includes an annular stator core surrounding the central axis. A fluid can flow through the flow pipe. The stator further includes coils located on the stator core. The flow pipe includes a connection pipes extending in the axial direction and arranged in a circumferential direction. Each of the connection pipes is located radially inward with respect to the coils and is in direct or indirect contact with the stator core.

### CROSS-REFERENCE TO RELATED APPLICATIONS

This is a U.S. national stage of application No. PCT/JP2022/041411, filed on Nov. 7, 2022, and with priority under 35 U.S.C. § 119(a) and 35 U.S.C. § 365(b) being claimed from Japanese Patent Application No. 2021-181527, filed on Nov. 5, 2021, Japanese Patent Application No. 2021-181528, filed on Nov. 5, 2021, and Japanese Patent Application No. 2021-181529, filed on Nov. 5, 2021, the entire disclosures of which are hereby incorporated herein by reference.

### 1. FIELD OF THE INVENTION

The present disclosure relates to a motor and an aircraft.

### 2. BACKGROUND

Conventionally, an air-cooled motor is known. For example, a rotor is rotatably connected on a base to which a stator is fixed. With a hole provided in a lid body installed on the rotor, circulation of air inside the motor is promoted.

However, there is a possibility that the inside of the motor cannot be sufficiently cooled only by air cooling. For example, in a motor requiring high torque, the amount of heat generated by a stator or the like may increase as the output increases.

### SUMMARY

A motor according to an example embodiment of the present disclosure includes a rotor, a stator, and a flow pipe. The rotor is rotatable about a central axis extending in an axial direction. The stator includes an annular stator core surrounding the central axis. A fluid can flow through the flow pipe. The stator further includes coils located on the stator core. The flow pipe includes connection pipes extending in the axial direction and arranged in the circumferential direction. Each of the connection pipes is located radially inward with respect to the coil, and is in direct or indirect contact with the stator core.

An example embodiment of a motor according to the present disclosure includes a rotor, a stator, and a heat radiation portion. The rotor is rotatable about a central axis extending in an axial direction. The stator includes a stator core surrounding the central axis. The heat radiation portion includes a heat radiator. The stator further includes a coil. The coil is located on the stator core. In the coil, axially outward is a direction from the center portion to an end portion in the axial direction of the coil. The heat radiation portion covers at least a portion of a portion of the coil axially outward with respect to the stator core.

An example embodiment of a motor according to the present disclosure includes a rotor, a stator, and a flow pipe. The rotor is rotatable about a central axis extending in an axial direction. The stator includes an annular stator core surrounding the central axis. A fluid can flow through the flow pipe. The stator further includes a coil located on the stator core. The coil includes a first coil head and a second coil head. The first coil head is located on one axial side with respect to the stator core. The second coil head is located on another axial side with respect to the stator core. The flow pipe includes at least one cooling pipe of a first cooling pipe, a second cooling pipe, a third cooling pipe, a fourth cooling pipe, a fifth cooling pipe, and a sixth cooling pipe. The first cooling pipe is located on one axial side with respect to the first coil head, opposes the first coil head in the axial direction, and extends in the circumferential direction. The second cooling pipe is located on one axial side with respect to the stator core and radially inward with respect to the first coil head, opposes the first coil head in the radial direction, and extends in the circumferential direction. The third cooling pipe is located on one axial side with respect to the stator core and radially outward with respect to the first coil head, opposes the first coil head in the radial direction, and extends in the circumferential direction. The fourth cooling pipe is located on the other axial side with respect to the second coil head, opposes the second coil head in the axial direction, and extends in the circumferential direction. The fifth cooling pipe is located on another axial side with respect to the stator core and radially inward with respect to the second coil head, opposes the second coil head in the radial direction, and extends in the circumferential direction. The sixth cooling pipe is located on the other axial side with respect to the stator core and radially outward with respect to the second coil head, opposes the second coil head in the radial direction, and extends in the circumferential direction.

An example embodiment of an aircraft of the present disclosure includes the above-described motor and a tank capable of storing a fluid to be supplied to the motor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is cross-sectional view illustrating a configuration example of a motor according to example embodiments of first and third disclosures.

FIG. 2 is a perspective view illustrating an appearance of the motor of FIG. 1.

FIG. 3 is a cross-sectional view of the motor taken along line III-III in FIG. 1.

FIG. 4 is a cross-sectional view of the motor taken along line IV-IV in FIG. 1.

FIG. 5 is a cross-sectional view of the motor taken along line V-V in FIG. 1.

FIG. 6 is a cross-sectional view illustrating another arrangement example of a cooling pipe in the vicinity of a first coil head according to example embodiments of the first and third disclosures.

FIG. 7 is a cross-sectional view illustrating another configuration example of a first cooling pipe to a third cooling pipe according to an example embodiment of the first disclosure.

FIG. 8 is a cross-sectional view illustrating another configuration example of a fourth cooling pipe to a sixth cooling pipe according to an example embodiment of the first disclosure.

FIG. 9 is a cross-sectional view illustrating another configuration example of an inflow pipe and an outflow pipe according to example embodiments of the first and third disclosures.

FIG. 10 is a diagram illustrating an example of an aircraft on which a motor is mounted.

FIG. 11 is a cross-sectional view illustrating a configuration example of a motor according to an example embodiment of a second disclosure.

FIG. 12 is a cross-sectional view of the motor taken along line III-III in FIG. 11.

FIG. 13 is a cross-sectional view of the motor taken along line IV-IV in FIG. 11.

FIG. 14 is a cross-sectional view illustrating another arrangement example of a cooling pipe in the vicinity of a first coil head according to an example embodiment of the second disclosure.

FIG. 15 is a cross-sectional view illustrating another configuration example of a first cooling pipe to a third cooling pipe according to example embodiments of the second and third disclosures.

FIG. 16 is a cross-sectional view illustrating another configuration example of a fourth cooling pipe to a sixth cooling pipe according to example embodiments of the second and third disclosures.

FIG. 17 is a cross-sectional view illustrating another configuration example of an inflow pipe and an outflow pipe according to example embodiments of the second and third disclosures.

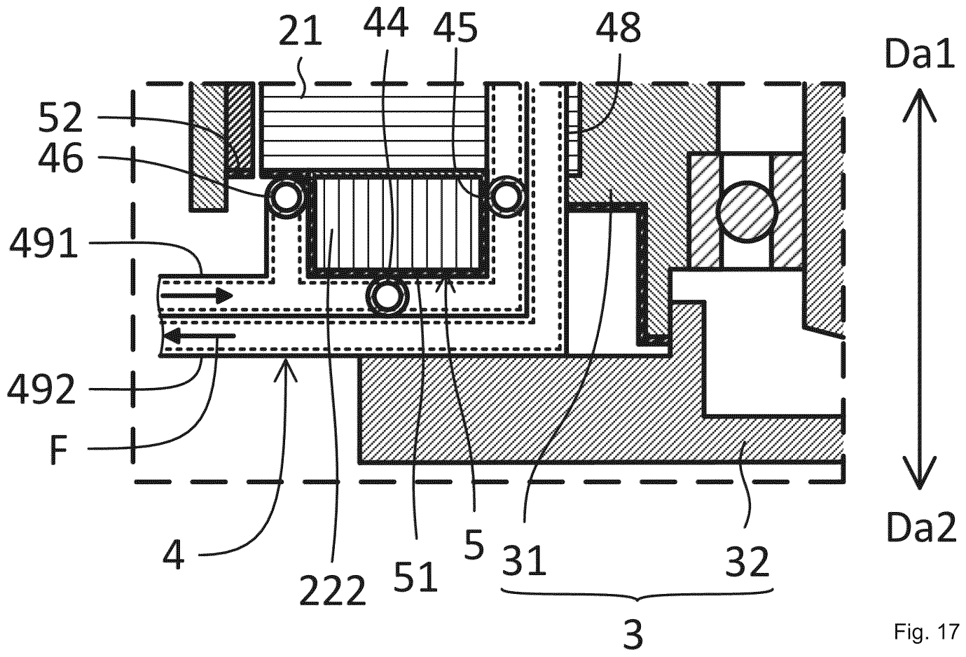

FIG. 18 is a cross-sectional view illustrating a configuration example of a motor according to a modification, illustrating example embodiments of the first and third disclosures.

FIG. 19 is a cross-sectional view of the motor taken along line III-III in FIG. 18.

FIG. 20 is a cross-sectional view of the motor taken along line IV-IV in FIG. 18.

FIG. 21 is a cross-sectional view illustrating another exemplary arrangement of a cooling pipe in the vicinity of the first coil head in FIG. 18.

FIG. 22 is a cross-sectional view illustrating another configuration example of the first cooling pipe to the third cooling pipe in FIG. 18.

FIG. 23 is a cross-sectional view illustrating another configuration example of the fourth cooling pipe to the sixth cooling pipe in FIG. 18.

FIG. 24 is a cross-sectional view illustrating another configuration example of the inflow pipe and the outflow pipe of

### DETAILED DESCRIPTION

Example embodiments will be described with reference to the drawings hereinafter.

In the present specification, in a motor 100, a direction parallel to a central axis CA is referred to as an “axial direction”, “axial”, or “axially”. As for the axial direction, a direction from a central portion to an end portion in the axial direction of a given component may be referred to as “axially outside”. In addition, a direction from an end portion to a central portion in the axial direction of a given component may be referred to as “axially inside”. A direction orthogonal to a predetermined axis, such as the central axis CA, is referred to as a “radial direction”, “radial”, or “radially”, and a rotational direction about a predetermined axis is referred to as “circumferential direction”, “circumferential”, or “circumferentially”. Of the e radial directions, a direction approaching a given axis is referred to as “radially inward”, and a direction separating from a given axis is referred to as “radially outward”.

In addition, in a positional relationship between any one of an azimuth, a line, and a plane and another, “parallel” includes not only a state in which both of them do not intersect at all no matter how long they extend, but also a state in which they are substantially parallel. In addition, “perpendicular” and “orthogonal” include not only a state in which both of them intersect each other at 90 degrees, but also a state in which they are substantially perpendicular and a state in which they are substantially orthogonal. That is, the terms, “parallel”, “perpendicular”, and “orthogonal” each include a state in which the positional relationship between the both of them has an angular deviation to the extent without departing from the gist of the present disclosure.

These terms are each a designation that is simply used for description, and thus do not intend to limit actual positional relationships, directions, names, and the like.

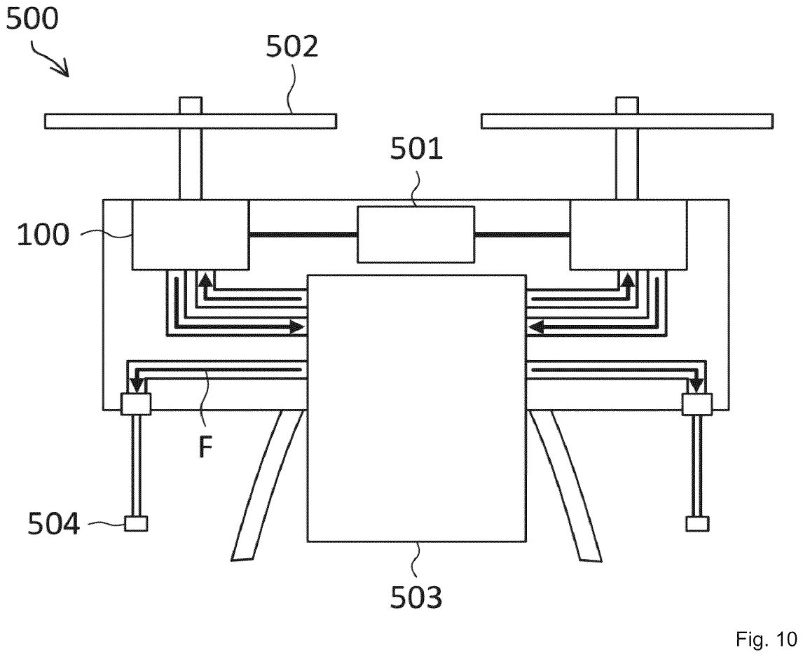

A motor 100 of the present example embodiment is a drive source of an aircraft 500 such as a drone, and is mounted on the aircraft 500. FIG. 10 is a diagram illustrating an example of the aircraft 500 on which the motor 100 is mounted. As illustrated in FIG. 10, the aircraft 500 includes the motor 100.

The aircraft 500 further includes a battery 501 and a propeller 502. For example, the motor 100 receives power supply from the battery 501 to rotationally drive the propeller 502.

The aircraft 500 of the present example embodiment is an agricultural flight vehicle that sprays a fluid F such as a pesticide. The aircraft 500 further includes a tank 503. The tank 503 can store the fluid F to be supplied to the motor 100. In the aircraft 500 of FIG. 10, as will be described later, the fluid F supplied from the tank 503 to the motor 100 flows inside the motor 100 through a flow pipe 4 to be described later, so that the motor 100 can be cooled, and particularly coils 22 of a stator 2 can be efficiently cooled. Therefore, the stator 2 can be sufficiently cooled, and the heat dissipation performance of the motor 100 can be improved. Note that the fluid F discharged from the motor 100 returns to the tank 503 in the present example embodiment.

The aircraft 500 also includes a sprayer 504. The sprayer 504 sprays the fluid F supplied from the tank 503 around. Alternatively, the sprayer 504 may spray the fluid F discharged from the motor 100 around. Note that the fluid F is not limited to the above example, and may be a liquid such as water. Moreover, the application of the motor 100 is not limited to the example described above. The motor 100 may be mounted on a device other than the aircraft 500.

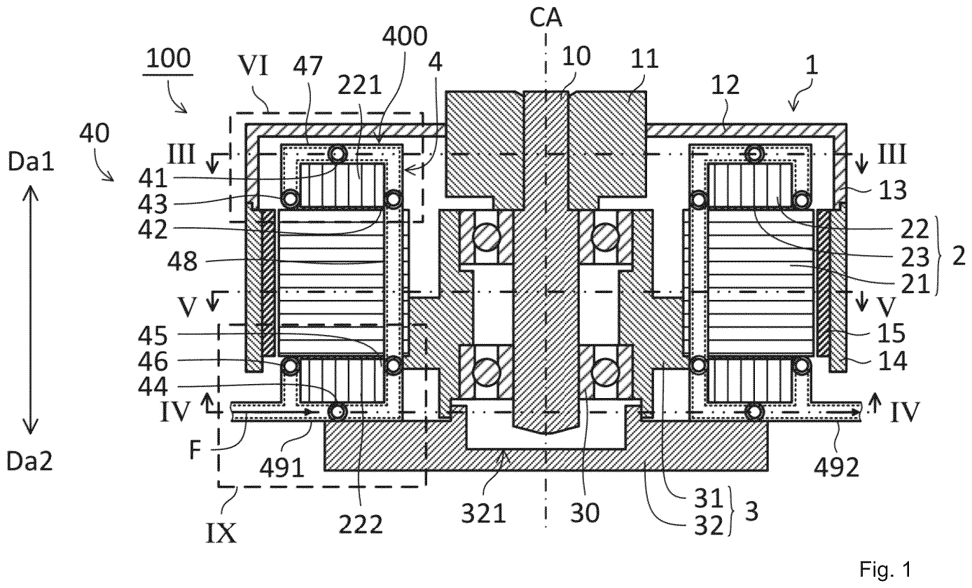

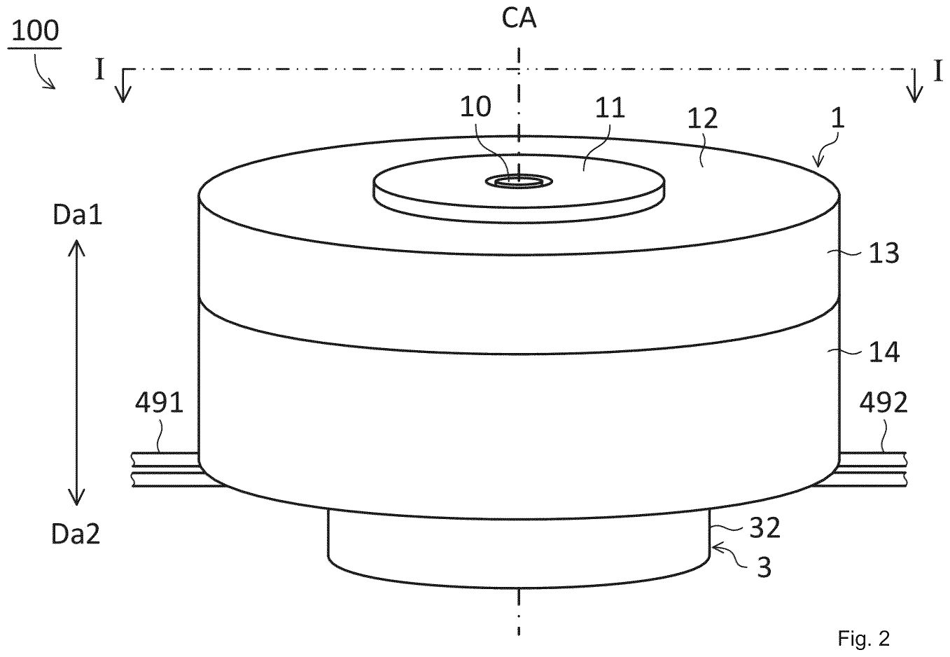

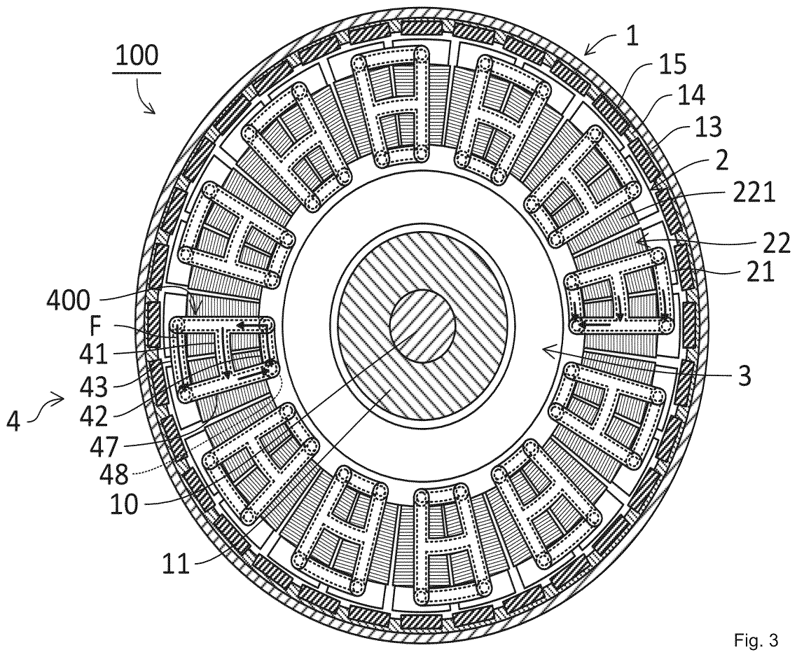

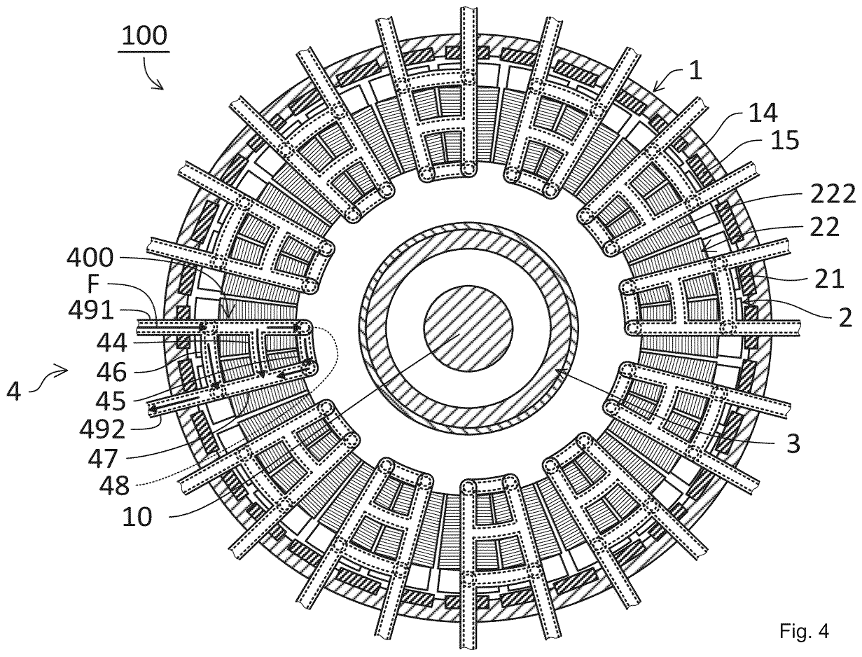

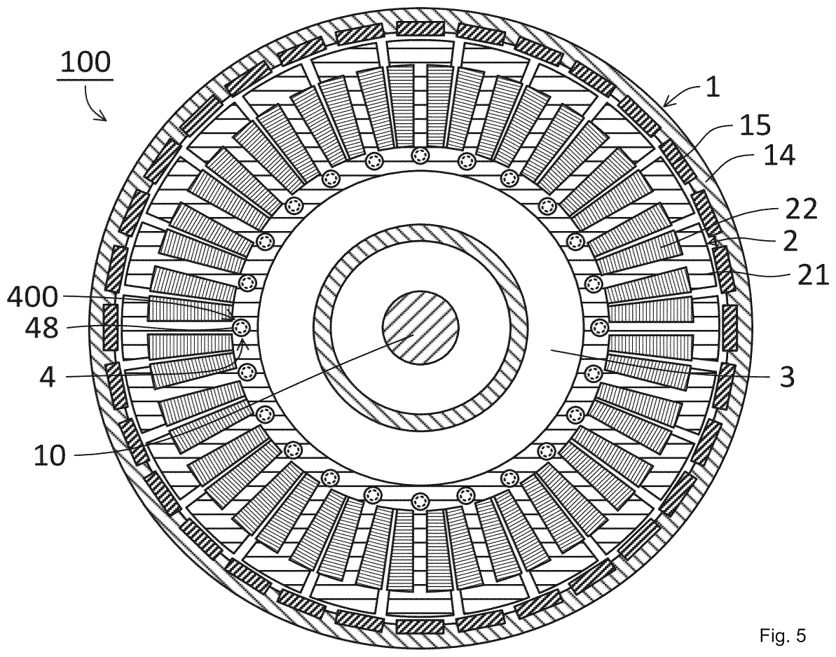

FIG. 1 is a cross-sectional view illustrating a configuration example of the motor 100. FIG. 2 is a perspective view illustrating an appearance of the motor 100. FIG. 3 is a cross-sectional view of the motor taken along line III-III in FIG. 1. FIG. 4 is a cross-sectional view of the motor taken along line IV-IV in FIG. 1. FIG. 5 is a cross-sectional view of the motor taken along line V-V in FIG. 1. Note that FIG. 1 shows the cross-sectional structure of the motor 100 when the motor 100 is cut on a virtual plane including the central axis CA. FIGS. 3 to 5 each illustrate a cross-sectional structure of the motor 100 when the motor 100 is cut along a virtual plane perpendicular to the central axis CA. FIGS. 3 and 5 show a cross-sectional structure of the motor 100 from one axial side Da1 toward the other axial side Da2. FIG. 4 also shows a cross-sectional structure of the motor 100 from the other axial side Da2 toward the one axial side Da1.

As illustrated in FIGS. 1 to 5, the motor 100 includes a rotor 1, the stator 2, a stator holder 3, and the flow pipe 4.

The rotor 1 is rotatable about the central axis CA extending in the axial direction. As described above, the motor 100 includes the rotor 1. The rotor 1 includes a cylindrical shaft 10, a rotor hub 11, a rotor lid 12, a rotor cylindrical portion 13, a rotor core 14, and a magnet 15. The shaft 10 extends axially along the central axis CA. The rotor hub 11 has an annular shape surrounding the central axis CA, and is fixed to a radially outer surface of the shaft 10. The rotor lid 12 is located on the one side Da1 in the axial direction with respect to the stator 2, and extends radially outward from the radially outer end of the rotor hub 11. The rotor cylindrical portion 13 has a cylindrical shape surrounding the central axis CA, and extends in the other axial side Da2 from the radially outer end of the rotor lid 12. The rotor core 14 and the magnet 15 are disposed radially outward with respect to the stator 2. The rotor core 14 is a cylindrical magnetic body surrounding the central axis CA, and extends in the other axial side Da2 from an end of the rotor cylindrical portion 13 on the other axial side Da2. The magnet 15 is located on a radially inner surface of the rotor core 14 and faces the stator 2 in the radial direction. In the magnet 15, magnetic poles different from each other (that is, an N pole and an S pole) are alternately arranged in the circumferential direction. The magnet 15 may be an annular member surrounding the central axis CA, or may be configured of a plurality of magnetic pole pieces arranged in the circumferential direction.

The stator 2 rotationally drives the rotor 1 in accordance with supply of electric power. The stator 2 includes the annular stator core 21 surrounding the central axis CA. As described above, the motor 100 includes the stator 2. The stator core 21 is a laminated body in which electromagnetic steel plates are laminated in the present example embodiment.

The stator 2 further includes a plurality of coils 22 arranged on the stator core 21. Specifically, the stator 2 further includes an insulator 23 having electrical insulation. The coil 22 is formed of a conductive wire wound around the stator core 21 via the insulator 23. The plurality of coils 22 are arranged in the circumferential direction.

Each of the coils 22 includes a first coil head 221 and a second coil head 222. The first coil head 221 is located on the one axial side Da1 with respect to the stator core 21. The second coil head 222 is located on the other axial side Da2 with respect to the stator core 21. That is, the first coil head 221 is a portion of the coil 22 on the one axial side Da1 with respect to the stator core 21, and the second coil head 222 is a portion of the coil 22 on the other axial side Da2 with respect to the stator core 21. Hereinafter, the first coil head 221 and the second coil head 222 may be collectively referred to as a “coil head 220”.

The stator holder 3 holds the stator 2. As described above, the motor 100 includes the stator holder 3. The stator holder 3 includes a holder cylindrical portion 31. The holder cylindrical portion 31 is disposed radially inner side with respect to the stator core 21 and holds the stator core 21. The holder cylindrical portion 31 has a cylindrical shape that surrounds the central axis CA and extends in the axial direction. The holder cylindrical portion 31 extends in the one axial side Da1 from a holder plate 32. The shaft 10 is inserted into the holder cylindrical portion 31, and a bearing 30 is disposed between the holder cylindrical portion 31 and the shaft 10. The holder cylindrical portion 31 rotatably supports the shaft 10 via the bearing 30. The bearing 30 is a ball bearing in FIG. 1, but is not limited to this example and may be another type of bearing such as a sliding bearing.

The stator holder 3 further includes the holder plate 32. The holder plate 32 is located on the other axial side Da2 with respect to the stator core 21, and extends in a direction intersecting the axial direction. An end portion of the holder cylindrical portion 31 on the other axial side Da2 is connected to an end surface on the one axial side Da1 of the holder plate 32. In the present example embodiment, the holder plate 32 is a separate body from the holder cylindrical portion 31, but is not limited to this example, and may be integrated with the holder cylindrical portion 31.

The holder plate 32 includes a holder recess 321. The holder recess 321 is located on an end surface on the one axial side Da1 of the holder plate 32 and is recessed in the other axial side Da2. The holder recess 321 is connected to a space inside the holder cylindrical portion 31. An end portion of the shaft 10 on the other axial side Da2 is inserted into the holder recess 321.

Preferably, at least a part of the flow pipe 4 is in contact with the stator holder 3. Heat is transferred from the coil 22 to the stator holder 3 via the stator core 21. Therefore, by bringing the flow pipe 4 into contact with the stator holder 3, the heat transmitted from the coil 22 can be dissipated to the fluid F. However, this example does not exclude a configuration in which the entire flow pipe 4 is not in contact with the stator holder 3.

The fluid F can flow through the flow pipe 4. As described above, the motor 100 includes the flow pipe 4. For example, the inside of the motor 100 can be cooled by allowing the fluid F supplied from the outside of the motor 100 to flow through the flow pipe 4. The flow pipe 4 includes first to sixth cooling pipes 41 to 46, a communication pipe 47, a plurality of connection pipes 48, an inflow pipe 491, and an outflow pipe 492. Hereinafter, the first cooling pipe 41 to the sixth cooling pipe 46 may be collectively referred to as a “cooling pipe 40”.

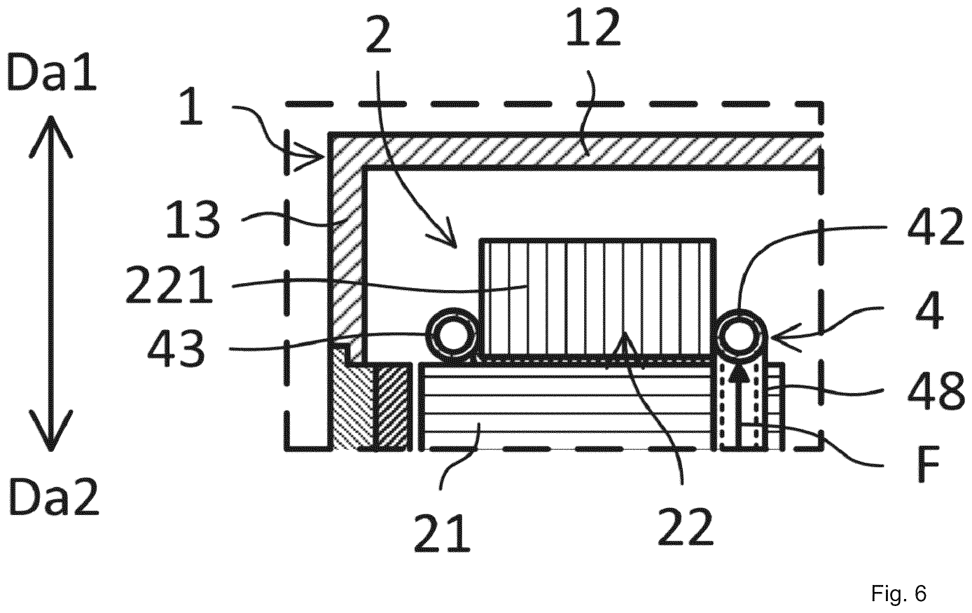

In the present example embodiment, as illustrated in FIG. 1, a part of the flow pipe 4 (for example, the first cooling pipe 41 to be described later or the like) is disposed between the rotor lid 12 and the stator 2 in the axial direction. However, the present disclosure is not limited to this example, and a part of the flow pipe 4 may not be disposed between the rotor lid 12 and the stator 2 in the axial direction. FIG. 6 is a cross-sectional view illustrating another arrangement example of the cooling pipe 40 in the vicinity of the first coil head 221. Note that FIG. 6 corresponds to a cross-sectional structure of a portion VI surrounded by a broken line in FIG. 1. For example, as illustrated in FIG. 6, the flow pipe 4 may be located on the other axial side Da2 with respect to an end on the one axial side Da1 of the first coil head. Thus, for example, the flow pipe 4 can be prevented from coming into contact with the rotor 1 (in particular, the rotor lid 12).

In the present example embodiment, as illustrated in FIGS. 1 and 3 to 5, the flow pipe 4 includes a plurality of pipe units 400. Each of the pipe units 400 includes each of the first cooling pipe 41 to the sixth cooling pipe 46, two communication pipes 47, two connection pipes 48, and each of the inflow pipe 491 and the outflow pipe 492. The respective pipe units 400 are arranged side by side in the circumferential direction. In addition, in FIGS. 3 to 5, one pipe unit 400 is disposed for two coils 22 arranged in the circumferential direction. However, the present disclosure is not limited to the examples of FIGS. 3 to 5, and in at least some of the coils 22, one pipe unit 400 may be arranged for one coil 22. In this way, the cooling efficiency of the coil 22 is further improved.

The first cooling pipe 41 is located on the one axial side Da1 with respect to the first coil head 221. The first cooling pipe 41 faces the first coil head 221 in the axial direction and extends in the circumferential direction. In the present example embodiment, the first cooling pipe 41 is connected to the communication pipe 47.

The second cooling pipe 42 is located on one axial side Da1 with respect to the stator core 21 and radially inward with respect to the first coil head 221. The second cooling pipe 42 faces the first coil head 221 in the radial direction and extends in the circumferential direction. In the present example embodiment, the second cooling pipe 42 is connected to a portion on the one axial side Da1 of the connection pipe 48.

The third cooling pipe 43 is located on the one axial side Da1 with respect to the stator core 21 and radially outward with respect to the first coil head 221. The third cooling pipe 43 faces the first coil head 221 in the radial direction and extends in the circumferential direction. In the present example embodiment, the third cooling pipe 43 is connected to the communication pipe 47.

The fourth cooling pipe 44 is arranged in the other axial side Da2 with respect to the second coil head 222. The fourth cooling pipe 44 faces the second coil head 222 in the axial direction and extends in the circumferential direction. In the present example embodiment, the fourth cooling pipe 44 is connected to the inflow pipe 491 and the outflow pipe 492.

The fifth cooling pipe 45 is located on the other axial side Da2 with respect to the stator core 21 and radially inward with respect to the second coil head 222. The fifth cooling pipe 45 faces the second coil head 222 in the radial direction and extends in the circumferential direction. In the present example embodiment, the fifth cooling pipe 45 is connected to a portion on the other axial side Da2 of the connection pipe 48.

The sixth cooling pipe 46 is located on the other axial side Da2 with respect to the stator core 21 and radially outward with respect to the second coil head 222. The sixth cooling pipe 46 faces the second coil head 222 in the radial direction and extends in the circumferential direction. In the present example embodiment, the sixth cooling pipe 46 is connected to the inflow pipe 491 and the outflow pipe 492.

In the present example embodiment, the flow pipe 4 includes all of the first cooling pipe 41 to the sixth cooling pipe 46. However, the present disclosure is not limited to this example, and some of them may be omitted. That is, the flow pipe 4 only needs to include at least one cooling pipe 40 of the first cooling pipe 41 to the sixth cooling pipe 46. Thus, the fluid F supplied from the outside of the motor 100 to the flow pipe 4 flows through at least one of the cooling pipes 40 described above. By disposing at least one of the above-described cooling pipes 40 at a position facing the coil head 220 of the coil 22 having a large amount of heat generation, it is possible to efficiently cool the coil 22. For example, as will be described later, by disposing at least one of the cooling pipes 40 described above directly or indirectly with the coil 22, it is possible to cool the coil 22 with the fluid F in the cooling pipe 40. In addition, even if at least one of the cooling pipes 40 described above is disposed away from the coil 22, it is possible to promote heat dissipation of the coil 22 by cooling the air around the coil 22 with the fluid F in the cooling pipe 40. Therefore, the cooling efficiency of the coil 22 can be improved. Therefore, the stator 2 can be sufficiently cooled, and the heat dissipation performance of the motor 100 can be improved.

The communication pipe 47 extends at least in the radial direction. A radially inner end of the communication pipe 47 is connected to the connection pipe 48, and is connected to the second cooling pipe 42 via the one axial side Da1 of the connection pipe 48. The radially outer end of the communication pipe 47 is connected to the third cooling pipe 43. The communication pipe 47 is also connected to the first cooling pipe 41. In the present example embodiment, the communication pipe 47 is located on the one axial side Da1 with respect to the first coil head 221. However, the present disclosure is not limited to this example. The communication pipe 47 may be located on the other axial side Da2 with respect to the end portion on the one axial side Da1 of the first coil head 221 and, for example, may be disposed between the first coil heads 221 adjacent to each other in the circumferential direction.

The insides of the first cooling pipe 41, the third cooling pipe 43, and the connection pipe 48 communicate with each other via the inside of the communication pipe 47. Note that the second cooling pipe 42 communicates with the first cooling pipe 41 and the third cooling pipe 43 via the inside of the communication pipe 47 and the connection pipe 48.

The insides of the fourth cooling pipe 44, the sixth cooling pipe 46, and the connection pipe 48 communicate with each other via the insides of the inflow pipe 491 and the outflow pipe 492. The fifth cooling pipe 45 communicates with the fourth cooling pipe 44 and the sixth cooling pipe 46 via the insides of the connection pipe 48, the inflow pipe 491, and the outflow pipe 492.

Preferably, the first cooling pipe 41 to the sixth cooling pipe 46 (that is, at least one of the cooling pipes 40 described above) are in direct or indirect contact with the coil 22. For example, at least one of the first cooling pipe 41 to the third cooling pipe 43 may be in direct contact with the first coil head 221, or may be in indirect contact with the first coil head 221 via an inclusion such as an adhesive. Further, at least one of the fourth cooling pipe 44 to the sixth cooling pipe 46 may be in direct contact with the second coil head 222, or may be in indirect contact with the second coil head 222 via an inclusion such as an adhesive. When the cooling pipe 40 is in direct or indirect contact with the coil 22, the coil 22 can be cooled more efficiently.

However, the present disclosure is not limited to the above example, and the first cooling pipe 41 may face the first coil head 221 in the axial direction with a gap. At least one of the second cooling pipe 42 and the third cooling pipe 43 may face the first coil head 221 in the radial direction with a gap. The fourth cooling pipe 44 may face the second coil head 222 in the axial direction with a gap. At least one of the fifth cooling pipe 45 and the sixth cooling pipe 46 may face the second coil head 222 in the radial direction with a gap. The above-described example does not exclude a configuration in which all of the first cooling pipe 41 to the sixth cooling pipe 46 are not in direct contact with the coil 22 and are not in indirect contact therewith.

Preferably, the flow pipe 4 includes at least one of the second cooling pipe 42, the third cooling pipe 43, the fifth cooling pipe 45, and the sixth cooling pipe 46. That is, at least one of the cooling pipes 40 includes at least one of the second cooling pipe 42, the third cooling pipe 43, the fifth cooling pipe 45, and the sixth cooling pipe 46. More preferably, at least one of the cooling pipes 40 is in direct or indirect contact with the stator core 21. For example, at least one of the second cooling pipe 42 and the third cooling pipe 43 may be in direct contact with the end on the one axial side Da1 of the stator core 21, or may be in indirect contact with the end on the one axial side Da1 of the stator core 21 via an inclusion such as an adhesive. Further, at least one of the fifth cooling pipe 45 and the sixth cooling pipe 46 may be in direct contact with the end on the other axial side Da2 of the stator core 21, or may be in indirect contact with the end on the other axial side Da2 of the stator core 21 via an inclusion such as an adhesive. Thus, the stator core 21 can be efficiently cooled by at least one of the second cooling pipe 42, the third cooling pipe 43, the fifth cooling pipe 45, and the sixth cooling pipe 46.

More preferably, the flow pipe 4 includes at least one of the second cooling pipe 42 and the fifth cooling pipe 45. The heat generated in the coil 22 is likely to be confined on the radially inner side rather than the radially outer side of the coil 22. Therefore, by disposing the cooling pipe 40 on the radially inner side of the coil 22, the heat dissipation of the coil 22 can be improved, and heat can be prevented from being confined.

However, the present disclosure is not limited to the above example. At least one of the second cooling pipe 42, the third cooling pipe 43, the fifth cooling pipe 45, and the sixth cooling pipe 46 may face the stator core 21 with a gap. In addition, the above-described example does not exclude a configuration in which all of the second cooling pipe 42, the third cooling pipe 43, the fifth cooling pipe 45, and the sixth cooling pipe 46 are not in direct contact with the stator core 21 and are not in indirect contact therewith.

In the present example embodiment, a plurality of first cooling pipes 41 to a plurality of sixth cooling pipes 46 (that is, at least one of the cooling pipes 40 described above) are arranged in the circumferential direction. Preferably, at least any cooling pipes 40 of the first cooling pipes 41 to the sixth cooling pipes 46 are arranged in the circumferential direction over the entire region in the circumferential direction.

For example, in FIG. 3, the plurality of first cooling pipes 41 are arranged in the circumferential direction over the entire region in the circumferential direction. The plurality of second cooling pipes 42 are arranged in the circumferential direction over the entire region in the circumferential direction, and the plurality of third cooling pipes 43 are arranged in the circumferential direction over the entire region in the circumferential direction. In FIG. 4, the plurality of fourth cooling pipes 44 are arranged in the circumferential direction over the entire region in the circumferential direction. In addition, the plurality of fifth cooling pipes 45 are arranged in the circumferential direction over the entire region in the circumferential direction, and the plurality of sixth cooling pipes 46 are arranged in the circumferential direction over the entire region in the circumferential direction. Note that the number of the first cooling pipes 41 to the sixth cooling pipes 46 arranged in the circumferential direction is not limited to the example of the present example embodiment, and may be three or more.

Accordingly, the first cooling pipe 41 to the sixth cooling pipe 46 (that is, at least one of the cooling pipes 40 described above) can cool the respective coils 22 in a wider range in the circumferential direction. However, the above-described example does not exclude a configuration in which at least one of the above-described cooling pipes 40 is arranged in the circumferential direction only in a part of the entire region in the circumferential direction. In addition, the above-described example does not exclude a configuration in which at least one of the above-described cooling pipes 40 is single.

In FIGS. 3 and 4, each of the first cooling pipe 41 to the sixth cooling pipe 46 has an arc shape when viewed from the axial direction. However, the present disclosure is not limited to these examples. Each of at least one cooling pipe 40 of the first cooling pipe 41 to the sixth cooling pipe 46 may have an annular shape surrounding the central axis CA.

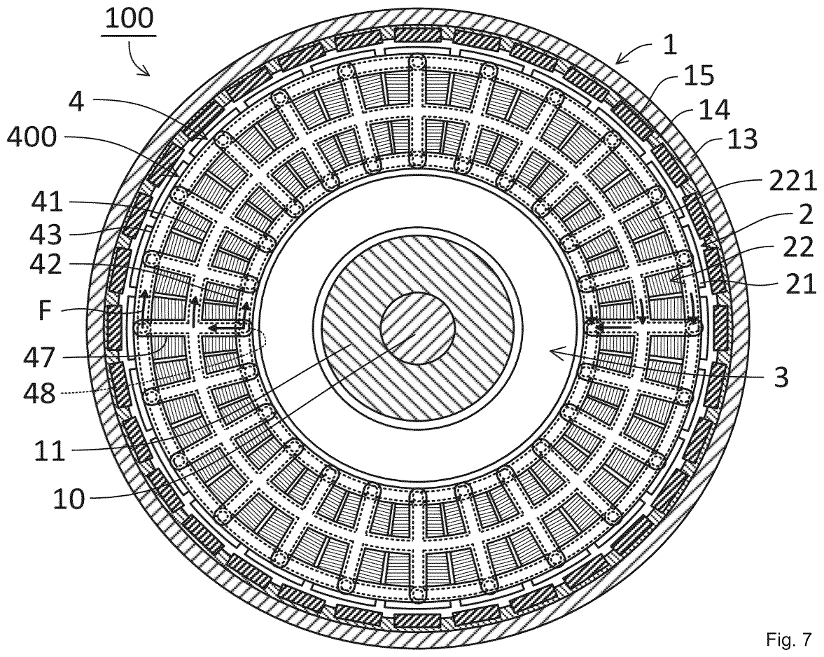

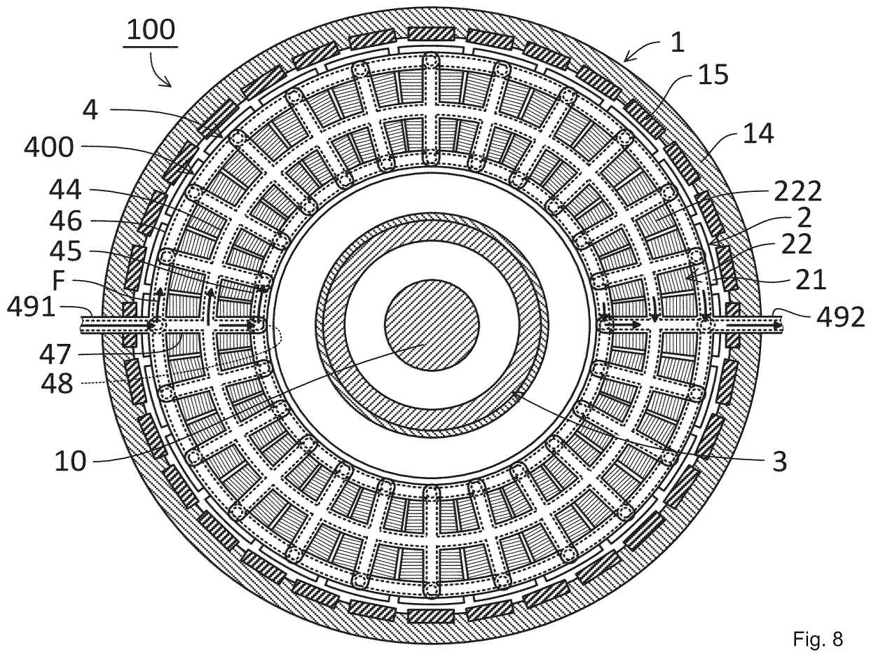

FIG. 7 is a cross-sectional view illustrating another configuration example of the first cooling pipe 41 to the third cooling pipe 43. FIG. 8 is a cross-sectional view illustrating another configuration example of the fourth cooling pipe 44 to the sixth cooling pipe 46. FIGS. 7 and 8 each illustrate a cross-sectional structure of the motor 100 when the motor 100 is cut along a virtual plane perpendicular to the central axis CA. FIG. 7 corresponds to a cross-sectional structure of the motor 100 taken along line III-III in FIG. 1, and the cross-sectional structure of the motor 100 is seen from one axial side Da1 toward the other axial side Da2. FIG. 8 corresponds to a cross-sectional structure of the motor 100 taken along line IV-IV in FIG. 1, and the cross-sectional structure of the motor 100 is seen from the other axial side Da2 toward the one axial side Da1.

For example, in FIG. 7, each of the first cooling pipe 41 to the third cooling pipe 43 is single, and has an annular shape when viewed from the axial direction. In FIG. 8, each of the fourth cooling pipe 44 to the sixth cooling pipe 46 is single, and has an annular shape when viewed from the axial direction. Even in this case, the first cooling pipe 41 to the sixth cooling pipe 46 (that is, at least one of the cooling pipes 40 described above) can cool the respective coils 22 in a wider range in the circumferential direction.

In FIGS. 7 and 8, the flow pipe 4 includes a single pipe unit 400. The pipe unit 400 includes each of the first cooling pipe 41 to the sixth cooling pipe 46, a plurality of communication pipes 47, a plurality of connection pipes 48, and each of the inflow pipe 491 and the outflow pipe 492. However, at least either the inflow pipe 491 or the outflow pipe 492 may be plural.

In FIG. 7, a plurality of communication pipes 47 are arranged in the circumferential direction, and one communication pipe 47 is disposed for each coil 22. The number of communication pipes 47 is the same as the number of coils 22 in FIG. 7, but is not limited to this example, and may be different from the number of coils 22.

In FIG. 8, the plurality of communication pipes 47 are also located on the other axial side Da2 of the stator 2, and connect the fourth cooling pipe 44 to the sixth cooling pipe 46 to each other. However, the present disclosure is not limited to this example, and in FIG. 8, the number of the communication pipes 47 located on the other axial side Da2 of the stator 2 may be single or may be omitted.

The connection pipes 48 each extend in the axial direction and are arranged in the circumferential direction. As described above, the flow pipe 4 includes the plurality of connection pipes 48. For example, the connection pipe 48 extends in the axial direction from the other axial side Da2 toward the one axial side Da1 with respect to the stator core 21. A portion on the one axial side Da1 of the connection pipe 48 is connected to the second cooling pipe 42 and the communication pipe 47. A portion on the other axial side Da2 of the connection pipe 48 is connected to the fifth cooling pipe 45, the inflow pipe 491, and the outflow pipe 492. Note that in FIG. 1, the connection pipe 48 extends linearly in the axial direction. However, the present disclosure is not limited to the example of FIG. 1, and each connection pipe 48 may not extend linearly.

Since the flow pipe 4 includes the connection pipe 48, the fluid F can be immediately caused to flow from a portion of the flow pipe 4 on the other axial side Da2 with respect to the stator core 21 toward a portion on the one axial side Da1 with respect to the stator core 21. For example, the motor 100 can immediately cause the cold fluid F, supplied from the outside of the motor 100, to flow to the portion of the flow pipe 4 on the one axial side Da1 with respect to the stator core 21. Therefore, the cooling efficiency of the first coil head 221 can be improved.

Each of the connection pipes 48 is disposed radially inward with respect to the coil 22 and is in direct or indirect contact with the stator core 21. For example, in the present example embodiment, each of the connection pipes 48 is inserted into a hole penetrating the stator core 21 in the axial direction. The connection pipe 48 may be in direct contact with the inner peripheral surface of the hole, or may be in indirect contact with the inner peripheral surface of the hole via an inclusion such as an adhesive. However, the present disclosure is not limited to this example. At least one connection pipe 48 may be disposed radially inward with respect to the stator core 21 and may be in direct or indirect contact with the radially inner end of the stator core 21. The fluid F supplied from the outside to the flow pipe 4 flows through the connection pipe 48. When the plurality of connection pipes 48 arranged in the circumferential direction are brought into contact with the stator core 21, the coil 22 having a large amount of heat generation can be cooled by the fluid F via the stator core 21. Therefore, the stator 2 can be sufficiently cooled, and the heat dissipation performance of the motor 100 can be improved. Since each of the connection pipes 48 is disposed radially inward with respect to the coil 22, it is possible to cool the rotor 1 while suppressing contact with the rotor 1.

Preferably, at least one connection pipe 48 is disposed radially inward with respect to each coil 22. For example, in the present example embodiment, as illustrated in FIGS. 3 to 5, one connection pipe 48 is disposed radially inward with respect to one coil 22. In this way, the individual coil 22 can be cooled by the fluid F flowing in the at least one connection pipe 48. Note that this example does not exclude a configuration in which the connection pipe 48 is not disposed radially inward in some of the coils 22.

Preferably, the connection pipe 48 is in contact with at least one of one axial side Da1 of the coil 22 with respect to the stator core 21 and the other axial side Da2 of the coil 22 with respect to the stator core 21. For example, in the present example embodiment, each connection pipe 48 is in contact with both of the above. Specifically, in each connection pipe 48, an end portion on the one axial side Da1 of the connection pipe 48 is in contact with the radially inner end of the first coil head 221. In addition, an end portion of the connection pipe 48 on the other axial side Da2 is in contact with the radially inner end of the second coil head 222. With such a configuration, by bringing the connection pipe 48 into contact with the coil 22, it is possible to more efficiently cool the coil 22 by the fluid F that flows in the connection pipe 48. However, this example does not exclude a configuration in which the connection pipe 48 is not in contact with both the one axial side Da1 and the other axial side Da2 of the coil 22 with respect to the stator core 21 in the at least one connection pipe 48.

The inflow pipe 491 is a part for allowing the fluid F flowing from the outside to the inside of the motor 100 to flow. The outflow pipe 492 is a part for allowing the fluid F flowing out from the inside to the outside of the motor 100 to flow. As described above, the flow pipe 4 includes the inflow pipe 491 and the outflow pipe 492. Each of the inflow pipe 491 and the outflow pipe 492 is disposed at the other axial side Da2 with respect to the stator 2. The inflow pipe 491 and the outflow pipe 492 are drawn out of the motor 100. By having the inflow pipe 491 and the outflow pipe 492, the flow pipe 4 can discharge the fluid F supplied from the outside of the motor 100 to the inflow pipe 491 to the outside of the motor 100 through the outflow pipe 492.

The inflow pipe 491 extends in a direction intersecting the axial direction, and axially faces a portion of the coil 22 on the other axial side Da2 with respect to the stator core 21. That is, the inflow pipe 491 faces the second coil head 222 in the axial direction. Preferably, the inflow pipe 491 is in direct or indirect contact with the second coil head 222. For example, the inflow pipe 491 may be in direct contact with the second coil head 222, or may be in indirect contact with the second coil head 222 via an inclusion such as an adhesive. In this way, the second coil head 222 can be cooled by the fluid F in the inflow pipe 491 by allowing the fluid F to flow from the outside of the motor 100 to the inflow pipe 491. Therefore, the cooling efficiency of the coil 22 can be further improved.

However, this example does not exclude a configuration in which the inflow pipe 491 is not in direct contact with and is not in indirect contact with the second coil head 222. For example, the inflow pipe 491 may be axially spaced apart from the second coil head 222.

The outflow pipe 492 extends in a direction intersecting the axial direction and faces the second coil head 222 in the axial direction. In the present example embodiment, the outflow pipe 492 is in direct or indirect contact with the second coil head 222, but may be axially spaced apart from the second coil head 222.

In the present example embodiment, the outflow pipe 492 is disposed side by side with the inflow pipe 491 in the circumferential direction. However, the present disclosure is not limited to this example, and the outflow pipe 492 may be aligned with the inflow pipe 491 in the axial direction. In addition, the outflow pipe 492 may be disposed away from the coil 22 in the axial direction.

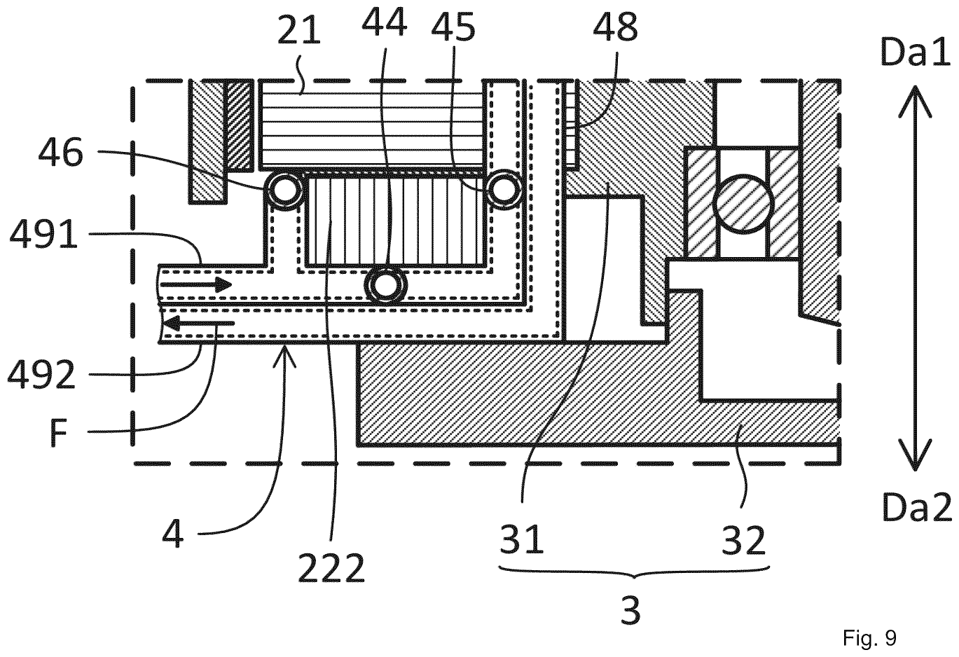

FIG. 9 is a cross-sectional view illustrating another configuration example of the inflow pipe 491 and the outflow pipe 492. Note that FIG. 9 corresponds to a cross-sectional structure of a part IX surrounded by a broken line in FIG. 1. In FIG. 9, the inflow pipe 491 faces the outflow pipe 492 in the axial direction, and is located on the one axial side Da1 with respect to the outflow pipe 492. The temperature of the fluid F flowing through the inflow pipe 491 is lower than that of the fluid F flowing through the outflow pipe 492. Therefore, by disposing the outflow pipe 492 as described above, the motor 100 can effectively cool the coil 22 with the cooler fluid F.

Note that in FIG. 9, the outflow pipe 492 is in contact with the inflow pipe 491 in the axial direction while it is a different body from the inflow pipe 491. However, the present disclosure is not limited to the example of FIG. 9, and the outflow pipe 492 may be integrated with the inflow pipe 491. For example, a path functioning as the inflow pipe 491 and a path functioning as the outflow pipe 492 may be formed by partitioning the inside of a single portion of the flow pipe 4 with a partition wall.

Preferably, at least one of the inflow pipe 491 and the outflow pipe 492 is disposed between the stator 2 and the holder plate 32, and extends in a direction intersecting the axial direction. For example, in the present example embodiment, the inflow pipe 491 and the outflow pipe 492 are disposed between the stator 2 and the holder plate 32, and are drawn out in the radial direction toward the outside of the motor 100. Thus, at least one of the inflow pipe 491 and the outflow pipe 492 can be drawn out of the motor 100 using the gap between the stator 2 and the holder plate 32. However, the above-described example does not exclude a configuration in which both the inflow pipe 491 and the outflow pipe 492 are not disposed between the stator 2 and the holder plate 32 and do not extend in the direction intersecting the axial direction.

Preferably, at least one of the inflow pipe 491 and the outflow pipe 492 is axially sandwiched between an end portion of the stator 2 on the other axial side Da2 and the holder plate 32. Specifically, an end portion of at least one of the inflow pipe 491 and the outflow pipe 492 on the one axial side Da1 is in contact with an end portion of the stator 2 on the other axial side Da2. An end portion of at least one of the inflow pipe 491 and the outflow pipe 492 on the other axial side Da2 is in contact with an end portion of the holder plate 32 on the one axial side Da1. For example, in the present example embodiment, both the inflow pipe 491 and the outflow pipe 492 are axially sandwiched between an end portion of the stator 2 on the other axial side Da2 and the holder plate 32. By sandwiching them between the stator 2 and the holder plate 32, it is possible to prevent a positional shift of at least one of the inflow pipe 491 and the outflow pipe 492 in the circumferential direction.

However, the above-described example does not exclude a configuration in which both the inflow pipe 491 and the outflow pipe 492 are not sandwiched between the stator 2 and the holder plate 32. Further, the present disclosure is not limited to the above example, and at least one of the inflow pipe 491 and the outflow pipe 492 may not be disposed between the stator 2 and the holder plate 32, and may be drawn out in the axial direction from the inside to the outside of the motor 100. For example, at least one of the inflow pipe 491 and the outflow pipe 492 may be inserted into a hole penetrating the holder plate 32 in the axial direction and drawn out to the other axial side Da2 with respect to the stator holder 3.

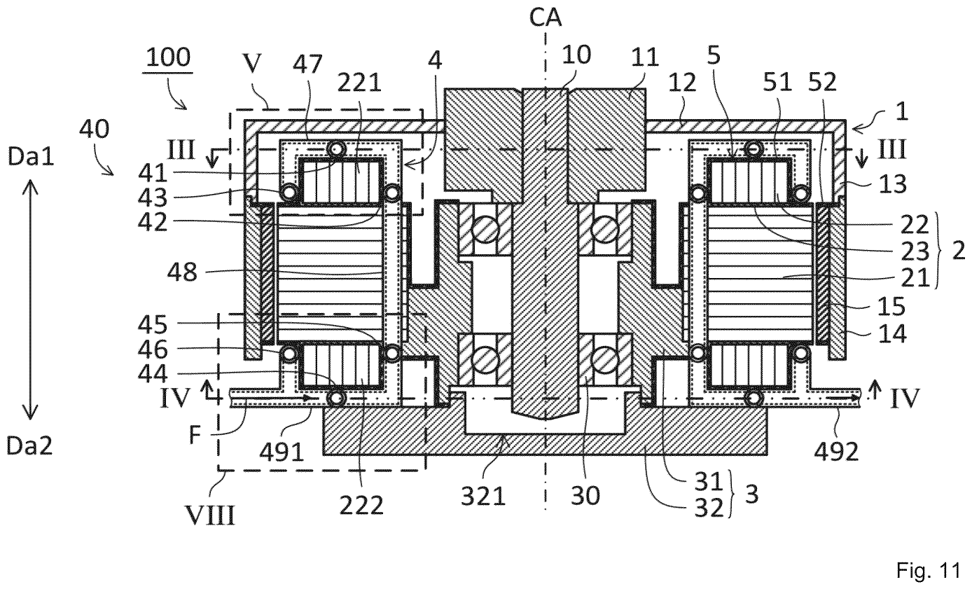

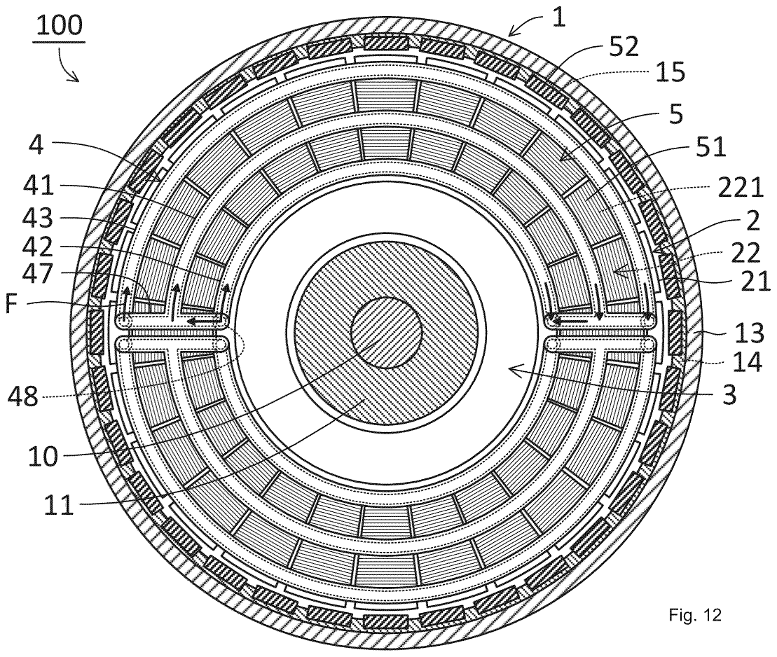

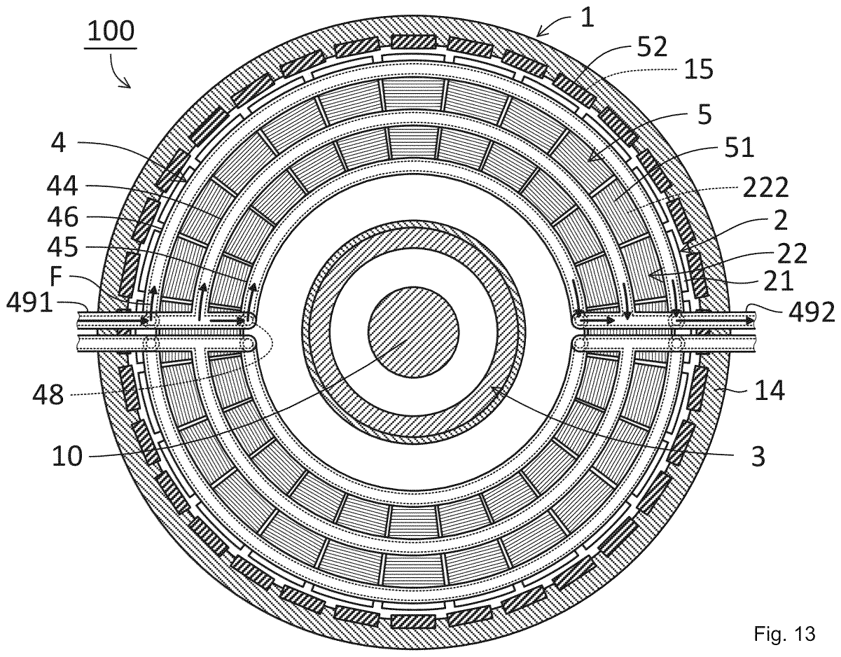

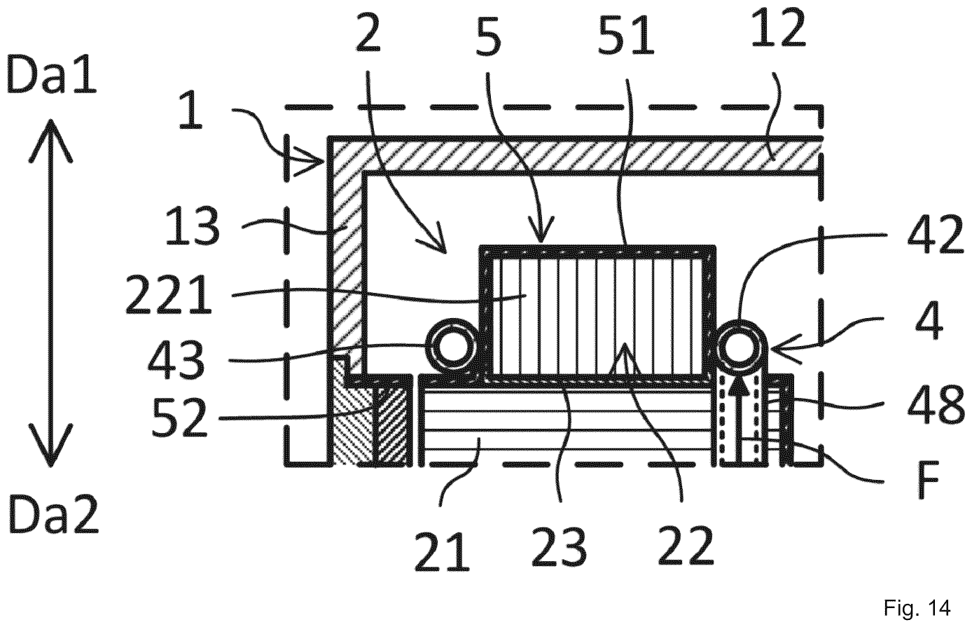

FIG. 11 is a cross-sectional view illustrating a configuration example of a motor according to an example embodiment of a second disclosure. FIG. 12 is a cross-sectional view of the motor taken along line III-III in FIG. 11. FIG. 13 is a cross-sectional view of the motor taken along line IV-IV in FIG. 11. FIG. 14 is a cross-sectional view illustrating another exemplary arrangement of cooling pipes in the vicinity of a first coil head according to an example embodiment of the second disclosure.

A motor according to an example embodiment of the second disclosure includes a dissipation part 5 in addition to the components included in the motor according to the example embodiment described with reference to FIGS. 1 to 10. Hereinafter, the heat radiation portion 5 will be mainly described. For other components, the same components as those in FIGS. 1 to 10 will be denoted by the same reference numerals as those in FIGS. 1 to 10, and the description thereof will be omitted.

The heat radiation portion 5 promotes heat dissipation of the member on which the heat radiation portion 5 is disposed. The heat radiation portion 5 includes a heat radiator, and the heat radiation portion 5 covers at least part of a portion of the coil 22 on the axially outer side of the stator core 21. Note that in the coil 22, axially outward is a direction from the center portion to an end portion in the axial direction of the coil 22. As described above, the motor 100 includes the heat radiation portion 5. For example, the heat radiation portion 5 covers only the surface of the coil head 220 in the coil 22. Note that the heat radiation portion 5 may cover only one of the surface of the first coil head 221 and the surface of the second coil head 222, or may cover both as illustrated in FIG. 11. By not covering a portion of the coil 22 on the axially inner side with respect to the axial end face of the stator core 21 with the heat radiation portion 5, it is possible to suppress the heat generated in the coil 22 from being confined inside the stator 2. In this way, the heat generated in the coil 22 can be efficiently dissipated by the heat radiation of the heat radiation portion 5. Note that if the portion on the axially inner side of the coil 22 is covered with the heat radiation portion 5, the heat radiated from the heat radiation portion 5 of this portion is transmitted to the coil 22 adjacent in the circumferential direction, and the output efficiency of the motor 100 may be reduced. Therefore, the stator 2 can be sufficiently cooled as compared with the case where the portion on the axially inner side of the coil 22 is covered with the heat radiation portion 5, and the heat dissipation performance of the motor 100 can be improved.

In the present example embodiment, the heat radiation portion 5 covers a surface at the axial end of the stator 2. For example, the heat radiation portion 5 covers an axial end surface of the stator core 21 in addition to the surface of the coil head 220. In other words, the heat radiation portion 5 includes a first heat radiation portion 51 that covers an axial end surface of the stator core 21. The first heat radiation portion 51 may cover only one of an end surface on the one axial side Da1 and an end surface on the other axial side Da2 of the stator 2 (particularly, the stator core 21), or may cover both as illustrated in FIG. 11. At an axial end of the stator 2, it is easier to secure a gap having a sufficient size between it and the rotor lid 12, the stator holder 3, and the like in the axial direction, as compared with, for example, between the stator core 21 and the magnet 15 in the radial direction. Therefore, by covering the surface of an axial end of the stator 2 with the heat radiation portion 5, the heat radiation portion 5 can radiate heat to a wide gap without confining the radiated heat. Therefore, the stator 2 can be cooled more efficiently.

Preferably, the heat radiation portion 5 further covers an axial end of the magnet 15. In other words, the heat radiation portion 5 includes a second heat radiation portion 52 that covers an axial end of the magnet 15. The second heat radiation portion 52 may cover only one of an end surface on the one axial side Da1 side and an end surface on the other axial side Da2 of the magnet 15, or may cover both as illustrated in FIG. 11. Thus, the magnet 15 that generates heat due to generation of eddy current or the like can be cooled by heat radiation in the heat radiation portion 5. Therefore, the life of the magnet 15 can be extended. In addition, it is easy to secure a gap having a sufficient size between an axial end of the magnet 15 and the rotor lid 12, the stator holder 3, and the like in the axial direction. Therefore, by covering the surface at an axial end of the magnet 15 with the heat radiation portion 5, the heat radiation portion 5 can radiate heat to a wide gap without confining the radiated heat. Therefore, the cooling performance of the magnet 15 can be improved. Note that this example does not exclude a configuration in which the heat radiation portion 5 does not cover an axial end of the magnet 15. That is, the second heat radiation portion 52 may be omitted.

In addition, in the present example embodiment, the heat radiation portion 5 also covers the radially inner surface of the stator core 21, the holder cylindrical portion 31, and the like. By covering the radially inner surface of the stator core 21, heat dissipation of the stator core 21 can be further improved. By covering the holder cylindrical portion 31, for example, the heat transmitted from the coil 22 to the holder cylindrical portion 31 via the stator core 21 can be efficiently dissipated. Therefore, the stator 2 can be more efficiently cooled. In addition, the heat radiation portion 5 may further cover the radially inner surface of the magnet 15, the radially outer surface of the stator core 21, the surface of the holder plate 32, and the like. However, the present disclosure is not limited to the example of the present example embodiment, and the heat radiation portion 5 may not cover at least one of the above-described portions.

In the present example embodiment, the heat radiation portion 5 does not cover the surface of the flow pipe 4. However, the present disclosure is not limited to this example, and the heat radiation portion 5 may cover at least part of the surface of the flow pipe 4. For example, the heat radiation portion 5 may cover at least one of the cooling pipes 40 of the first cooling pipe 41 to the sixth cooling pipe 46. In at least one of the cooling pipes 40, the heat radiation portion 5 may cover a partial region of the surface of the cooling pipe 40, or may cover the entire surface of the cooling pipe 40. The heat radiation portion 5 may cover at least one of the communication pipe 47, the connection pipe 48, the inflow pipe 491, and the outflow pipe 492. In at least one of them, the heat radiation portion 5 may cover a partial region of the surface or may cover the entire surface.

Next, for the heat radiator included in the heat radiation portion 5, a material having a high heat emissivity is used. For example, as the heat radiator, a ceramic material such as a metal oxide, a carbon-based material (graphite, carbon fiber, fullerene, carbon nanotube), a black organic pigment, or the like can be used.

The heat radiator has higher heat radiation property than that of the coil 22. In this way, the heat generated in the coil 22 can be efficiently radiated from the heat radiator.

Preferably, the heat radiator is an infrared ray emitter having a higher infrared ray emissivity than the coil 22. In this way, the heat generated in the coil 22 can be efficiently dissipated by the infrared radiation.

Preferably, the heat radiation portion 5 is a black coating film containing a heat radiator. By making the heat radiation portion 5 black, the heat emissivity is easily improved as compared with other colors (for example, white). Therefore, the cooling effect by the heat radiation of the heat radiation portion 5 can be improved. In addition, by forming the heat radiation portion 5 as a coating film, it is possible to suppress an increase in size of members such as the stator 2 and the magnet 15 covered by the heat radiation portion 5.

For example, in the present example embodiment, the heat radiation portion 5 is a coating film formed by applying and spraying a black body coating material. In this way, the film of the heat radiation portion 5 can be formed by a simple method. However, the present disclosure is not limited to this example, and the heat radiation portion 5 may be a coating film formed by means other than coating and spraying. For example, the heat radiation portion 5 may be formed by using physical vapor deposition, chemical vapor deposition, plating, a sol-gel method, or the like. Alternatively, the heat radiation portion 5 may be a deposited layer such as powder of a heat radiator or powder of a resin composition containing a heat radiator. This deposited layer can be formed by powder coating or the like. For example, in a powder-coated paint, a powder containing a composite oxide such as copper, chromium, or manganese as a heat radiator is dispersed in a liquid solvent. Note that the solvent includes, for example, dimethyl ether, toluene, 1-butanol, xylene, ethylbenzene, ethanol, and the like. The deposited layer can be formed by applying or spraying the coating material and removing the solvent by volatilization or heating.

Note that the above-described examples do not exclude a configuration in which the heat radiation portion 5 is not black, and do not exclude a configuration in which the heat radiation portion 5 is not a coating film.

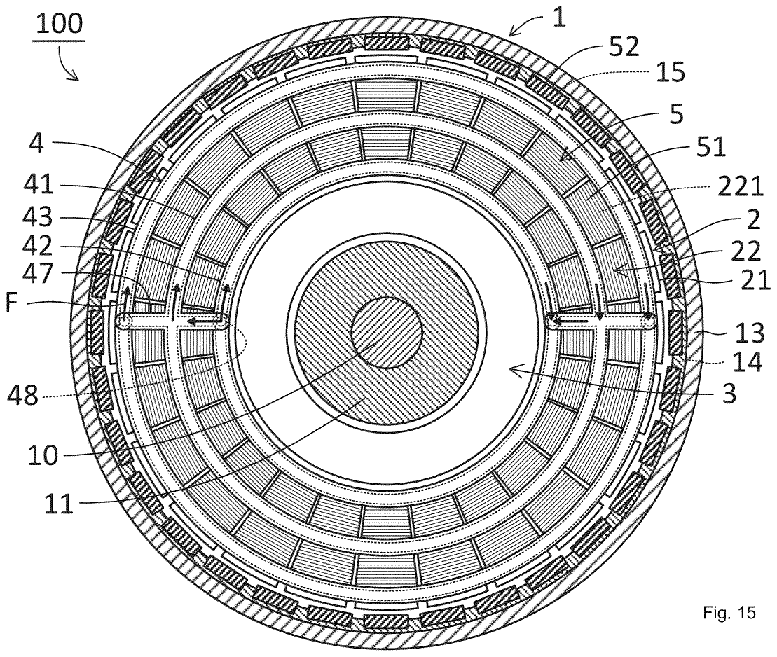

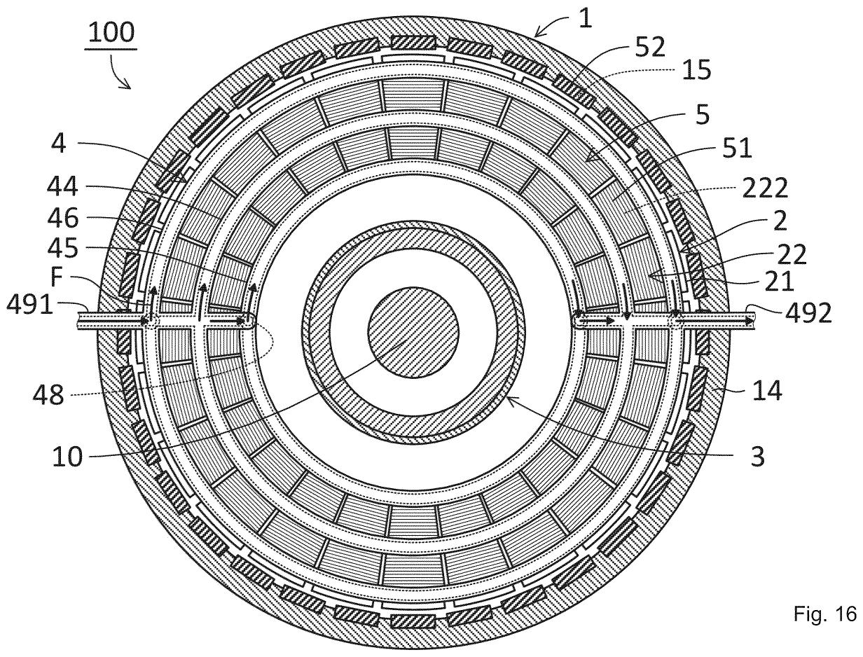

In FIGS. 12 and 13, each of the first cooling pipe 41 to the sixth cooling pipe 46 has an arc shape when viewed from the axial direction. However, the present disclosure is not limited to these examples. Each of at least one cooling pipe 40 of the first cooling pipe 41 to the sixth cooling pipe 46 may have an annular shape surrounding the central axis CA. FIG. 15 is a cross-sectional view illustrating another configuration example of the first cooling pipe 41 to the third cooling pipe 43. FIG. 16 is a cross-sectional view illustrating another configuration example of the fourth cooling pipe 44 to the sixth cooling pipe 46. FIGS. 15 and 16 each illustrate a cross-sectional structure of the motor 100 when the motor 100 is cut along a virtual plane perpendicular to the central axis CA. FIG. 15 corresponds to a cross-sectional structure of the motor 100 taken along line III-III in FIG. 11, and the cross-sectional structure of the motor 100 is seen from the one axial side Da1 toward the other axial side Da2. FIG. 16 corresponds to a cross-sectional structure of the motor 100 taken along line IV-IV in FIG. 11, and the cross-sectional structure of the motor 100 is seen from the other axial side Da2 toward the one axial side Da1.

For example, in FIG. 15, each of the first cooling pipe 41 to the third cooling pipe 43 is in an annular shape when viewed from the axial direction. In FIG. 16, each of the fourth cooling pipe 44 to the sixth cooling pipe 46 is in an annular shape when viewed from the axial direction. Even in this case, the first cooling pipe 41 to the sixth cooling pipe 46 (that is, at least one of the cooling pipes 40 described above) can cool the respective coils 22 in a wider range in the circumferential direction.

In the aircraft 500, the heat generated in the coil 22 of the motor 100 can be efficiently dissipated by the heat radiation of the heat radiation portion 5. Therefore, the stator 2 can be sufficiently cooled, and the heat dissipation performance of the motor 100 can be improved.

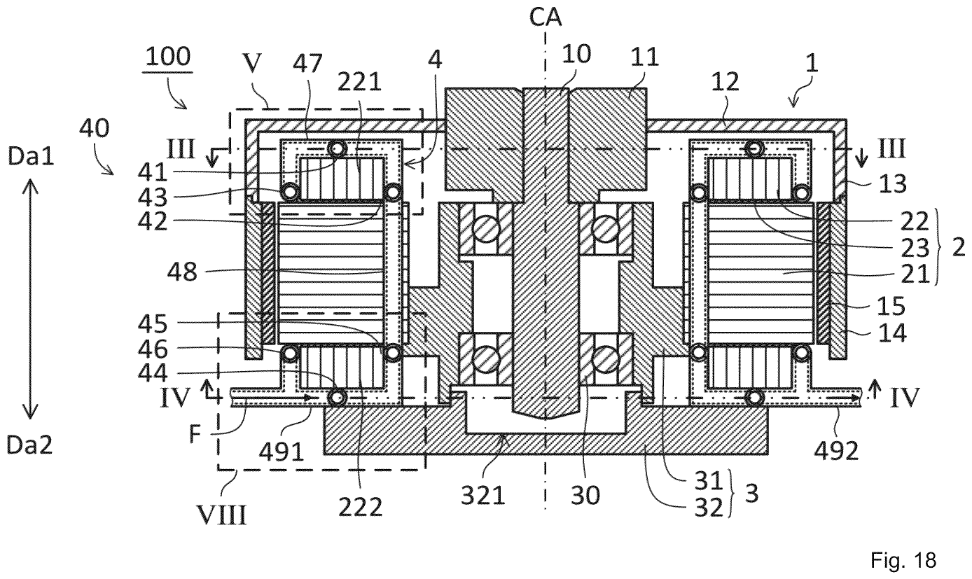

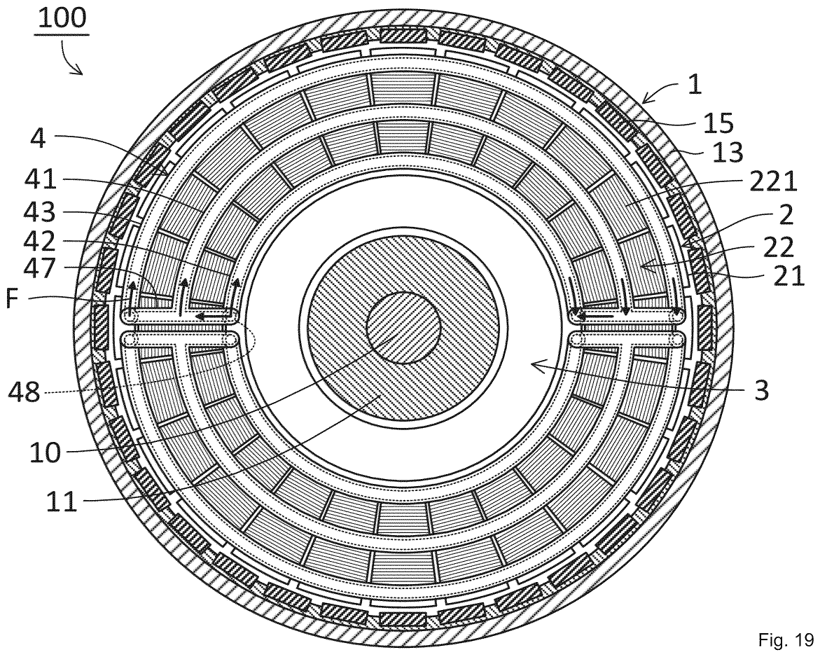

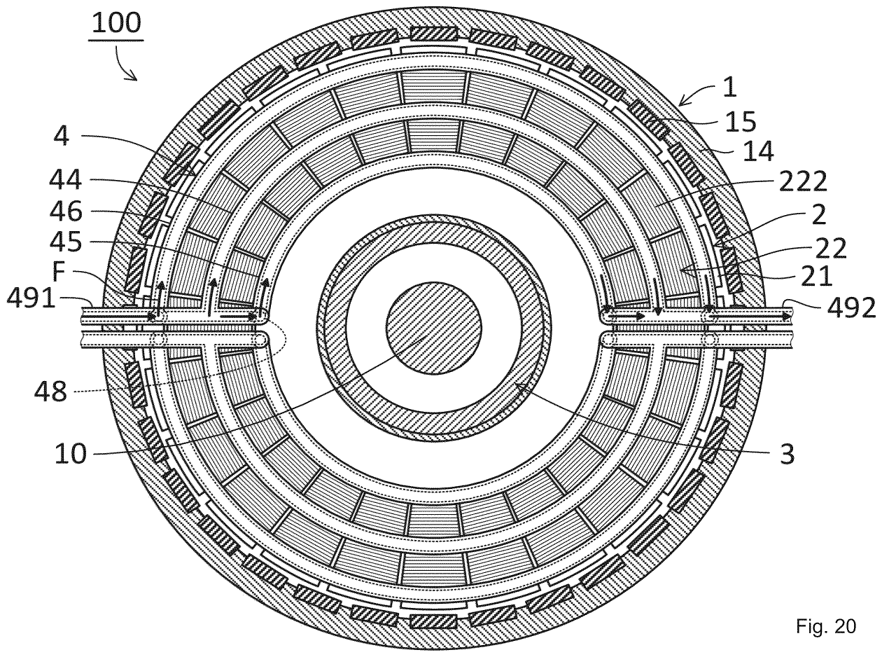

FIG. 18 is a cross-sectional view illustrating a configuration example of a motor according to a modification, illustrating example embodiments of the first and third disclosure. FIG. 19 is a cross-sectional view of the motor taken along line III-III in FIG. 18. FIG. 20 is a cross-sectional view of the motor taken along line IV-IV in FIG. 18.

The present modification has the same configuration as the motor illustrated in FIG. 11 except that the present modification has a configuration in which the heat radiation portion is omitted from the motor illustrated in FIG. 11. In other words, in the motor according to the present modification, the cooling pipe 40 is directly located on the coil 22 without passing through the heat radiation portion. Even with such a configuration, the same effects as that in the case described above can be obtained.

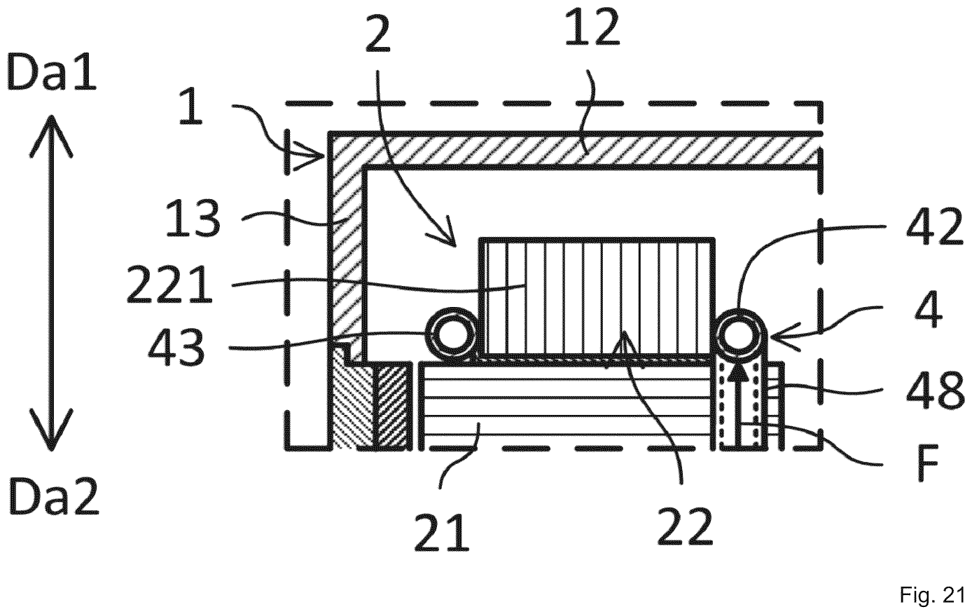

In the present modification, as illustrated in FIG. 18, a part of the flow pipe 4 is disposed between the rotor lid 12 and the stator 2 in the axial direction. However, the present disclosure is not limited to this example, and a part of the flow pipe 4 may not be disposed between the rotor lid 12 and the stator 2 in the axial direction. FIG. 21 is a cross-sectional view illustrating another arrangement example of a cooling pipe 40 in the vicinity of the first coil head 22 in FIG. 18. Note that FIG. 21 corresponds to a cross-sectional structure at a portion V surrounded by a broken line in FIG. 18. For example, as illustrated in FIG. 21, the flow pipe 4 may be located on the other axial side Da2 with respect to an end portion on the one axial side Da1 of the first coil head. Thus, for example, the flow pipe 4 can be prevented from coming into contact with the rotor 1 (in particular, the rotor lid 12).

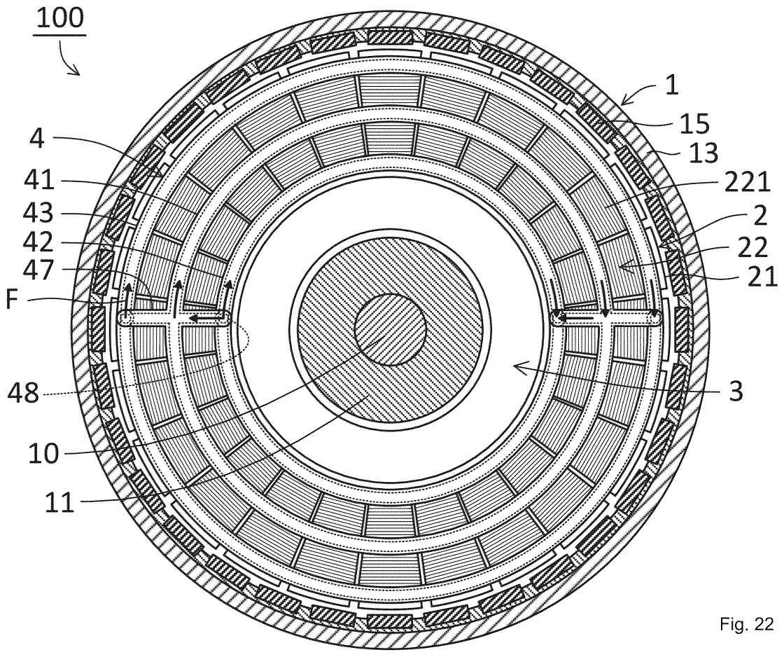

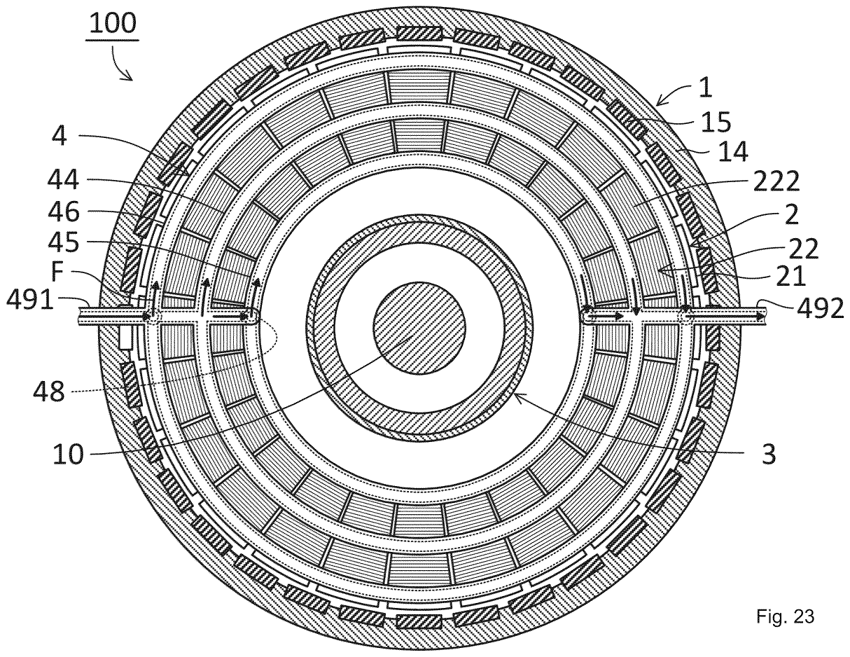

In FIGS. 19 and 20, each of the first cooling pipe 41 to the sixth cooling pipe 46 has an arc shape when viewed from the axial direction. However, the present disclosure is not limited to these examples. Each of at least one cooling pipe 40 of the first cooling pipe 41 to the sixth cooling pipe 46 may have an annular shape surrounding the central axis CA. FIG. 22 is a cross-sectional view illustrating another configuration example of the first cooling pipe 41 to the third cooling pipe 43. FIG. 23 is a cross-sectional view illustrating another configuration example of the fourth cooling pipe 44 to the sixth cooling pipe 46. FIGS. 22 and 23 each illustrate a cross-sectional structure of the motor 100 when the motor 100 is cut along a virtual plane perpendicular to the central axis CA. FIG. 22 corresponds to a cross-sectional structure of the motor 100 taken along line III-III in FIG. 1, and the cross-sectional structure of the motor 100 is seen from the one axial side Da1 toward the other axial side Da2. FIG. 23 corresponds to a cross-sectional structure of the motor 100 taken along line IV-IV in FIG. 1, and the cross-sectional structure of the motor 100 is seen from the other axial side Da2 toward the one axial side Da1.

For example, in FIG. 22, each of the first cooling pipe 41 to the third cooling pipe 43 is in an annular shape when viewed from the axial direction. In FIG. 23, each of the fourth cooling pipe 44 to the sixth cooling pipe 46 is in an annular shape when viewed from the axial direction. Even in this case, the first cooling pipe 41 to the sixth cooling pipe 46 (that is, at least one of the cooling pipes 40 described above) can cool the respective coils 22 in a wider range in the circumferential direction.

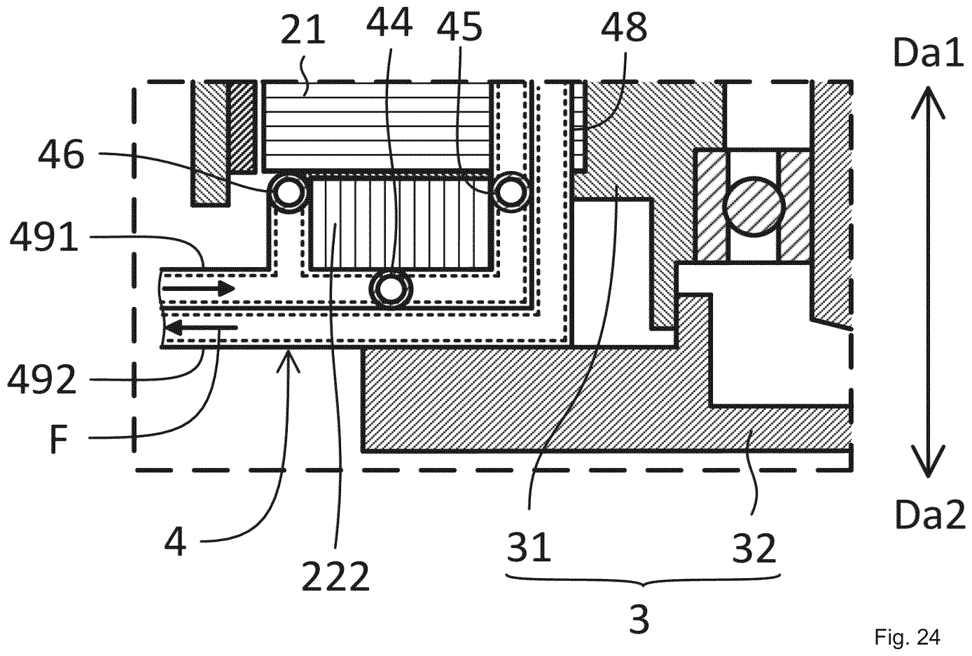

FIG. 24 is a cross-sectional view illustrating another configuration example of the inflow pipe 491 and the outflow pipe 492. Note that FIG. 24 corresponds to a cross-sectional structure of a portion VIII surrounded by a broken line in FIG. 18. In FIG. 24, the inflow pipe 491 faces the outflow pipe 492 in the axial direction, and is located on the one axial side Da1 with respect to the outflow pipe 492. The temperature of the fluid F flowing through the inflow pipe 491 is lower than that of the fluid F flowing through the outflow pipe 492. Therefore, by disposing the outflow pipe 492 as described above, the motor 100 can effectively cool the coil 22 with the cooler fluid F.

Note that in FIG. 24, the outflow pipe 492 is in contact with the inflow pipe 491 in the axial direction, while it is a different body from the inflow pipe 491. However, the present disclosure is not limited to the example of FIG. 24, and the outflow pipe 492 may be integrated with the inflow pipe 491. For example, a path functioning as the inflow pipe 491 and a path functioning as the outflow pipe 492 may be formed by partitioning the inside of a single portion of the flow pipe 4 with a partition wall.

The present disclosure has the following configurations.
(1) A motor comprising:
a rotor rotatable about a central axis extending in an axial direction;
a stator including a stator core having an annular shape and surrounding the central axis; and
a flow pipe allowing a fluid to flow through; wherein
the stator further includes coils located on the stator core;
the flow pipe includes connection pipes extending in the axial direction and arranged in a circumferential direction; and
each of the connection pipes is located radially inward with respect to each of the coils and is in direct or indirect contact with the stator core.
(2) The motor according to (1), wherein at least one of the connection pipes is located radially inward with respect to each of the coils.
(3) The motor according to (1) or (2), wherein
each of the connection pipes is in contact with at least one of:
one axial side of each of the coils with respect to the stator core; and
another axial side of each of the coils with respect to the stator core.
(4) The motor according to any of (1) to (3), wherein
the coil includes:
a first coil head located on one axial side with respect to the stator core; and
a second coil head located on another axial side with respect to the stator core, and
the flow pipe includes at least one cooling pipe of:
a first cooling pipe that is located on the one axial side with respect to the first coil head, opposes the first coil head in the axial direction, and extends in the circumferential direction;
a second cooling pipe that is located on the one axial side with respect to the stator core and radially inward with respect to the first coil head, opposes the first coil head in the radial direction, and extends in the circumferential direction;
a third cooling pipe that is located on the one axial side with respect to the stator core and radially outward with respect to the first coil head, opposes the first coil head in the radial direction, and extends in the circumferential direction;
a fourth cooling pipe that is located on the other axial side with respect to the second coil head, opposes the second coil head in the axial direction, and extends in the circumferential direction;
a fifth cooling pipe that is located on the other axial side with respect to the stator core and radially inward with respect to the second coil head, opposes the second coil head in the radial direction, and extends in the circumferential direction; and
a sixth cooling pipe located on the other axial side with respect to the stator core and radially outward with respect to the second coil head, opposes the second coil head in the radial direction, and extends in the circumferential direction.
(5) The motor according to (4), wherein the at least one cooling pipe is in direct or indirect contact with the coil.
(6) The motor according to (4) or (5), wherein
the at least one cooling pipe includes at least one of the second cooling pipe, the third cooling pipe, the fifth cooling pipe, and the sixth cooling pipe; and
the at least one cooling pipe is in direct or indirect contact with the stator core.
(7) The motor according to any of (4) to (6), wherein
the coils are arranged in the circumferential direction; and
a plurality of the at least one cooling pipe are arranged in the circumferential direction.
(8) The motor according to any of (1) to (7), wherein
the flow pipe further includes:
an inflow pipe to allow the fluid, flowing from an outside to an inside of the motor, to flow; and
an outflow pipe to allow the fluid, flowing out from the inside to the outside of the motor, to flow; and
each of the inflow pipe and the outflow pipe is drawn out of the motor.
(9) The motor according to (8), wherein the inflow pipe extends in a direction intersecting the axial direction, and axially opposes a portion on another axial side of each of the coils with respect to the stator core.
(10) The motor according to (8) or (9), wherein the inflow pipe opposes the outflow pipe in the axial direction, and is located on one axial side with respect to the outflow pipe.
(11) The motor according to any of (8) to (10), further comprising a stator holder located on a radially inner side with respect to the stator core and including a holder cylindrical portion that holds the stator core; wherein
the stator holder further includes a holder plate extending radially outward from the holder cylindrical portion; and
at least one of the inflow pipe and the outflow pipe is disposed between the stator and the holder plate, and extends in a direction intersecting the axial direction.
(12) The motor according to (10), wherein
one axial end of at least one of the inflow pipe and the outflow pipe is in contact with the other axial end of the stator; and
the other axial end of the at least one of the inflow pipe and the outflow pipe is in contact with one axial end of the holder plate.
(13) The motor according to any of (1) to (12), wherein the flow pipe is located on the other axial side with respect to one axial end of the first coil head.
(14) An aircraft comprising:
the motor according to any of (1) to (13); and
a tank capable of storing a fluid to be supplied to the motor.
(15) Further, the present disclosure has the following configurations.
A motor comprising:
a rotor rotatable about a central axis extending in an axial direction;
a stator including a stator core surrounding the central axis; and
a heat radiation portion including a heat radiator; wherein
the stator further includes a coil located on the stator core;
in the coil, axially outward is a direction from a center portion to an end portion in an axial direction of the coil; and
the heat radiation portion covers at least a portion of a portion axially outward with respect to the stator core.
(16) The motor according to (15), wherein the heat radiation portion covers a surface of an axial end portion of the stator.
(17) The motor according to (15) or (16), wherein
the rotor includes a magnet opposing the stator in the radial direction; and
the heat radiation portion further covers an axial end portion of the magnet.
(18) The motor according to any of (15) to (17), wherein the heat radiator has higher heat radiation property than heat radiation property of the coil.
(19) The motor according to any of (15) to (18), wherein the heat radiator is an infrared ray emitter having a higher infrared ray emissivity than infrared ray emissivity of the coil.
(20) The motor according to any of (15) to (19), wherein the heat radiation portion is black.
(21) The motor according to any of (15) to (20), wherein the heat radiation portion is a coating film.
(22) An aircraft comprising the motor according to any of (15) to (21).
Further, the present disclosure has the following configurations.
(23) A motor comprising:
a rotor rotatable about a central axis extending in an axial direction;
a stator including a stator core having an annular shape and surrounding the central axis; and
a flow pipe allowing a fluid to flow through; wherein
the stator further includes a coil located on the stator core;
the coil includes:
a first coil head located on one axial side with respect to the stator core; and
a second coil head located on another axial side with respect to the stator core; and
the flow pipe includes at least one cooling pipe of:
a first cooling pipe that is located on the one axial side with respect to the first coil head, opposes the first coil head in the axial direction, and extends in a circumferential direction;
a second cooling pipe that is located on the one axial side with respect to the stator core and radially inward with respect to the first coil head, opposes the first coil head in the radial direction, and extends in the circumferential direction;
a third cooling pipe that is located on the one axial side with respect to the stator core and radially outward with respect to the first coil head, opposes the first coil head in the radial direction, and extends in the circumferential direction;
a fourth cooling pipe that is located on the other axial side with respect to the second coil head, opposes the second coil head in the axial direction, and extends in the circumferential direction;
a fifth cooling pipe that is located on the other axial side with respect to the stator core and radially inward with respect to the second coil head, opposes the second coil head in the radial direction, and extends in the circumferential direction; and
a sixth cooling pipe located on the other axial side with respect to the stator core and radially outward with respect to the second coil head, opposes the second coil head in the radial direction, and extends in the circumferential direction.
(24) The motor according to (23), wherein the at least one cooling pipe is in direct or indirect contact with the coil.
(25) The motor according to (23) or (24), wherein
the at least one cooling pipe includes at least one of the second cooling pipe, the third cooling pipe, the fifth cooling pipe, and the sixth cooling pipe; and
the at least one cooling pipe is in direct or indirect contact with the stator core.
(26) The motor according to any of (23) to (25), wherein the flow pipe further includes a connection pipe extending in the axial direction from the other axial side toward one axial side with respect to the stator core.
(27) The motor according to any of (23) to (26), wherein
the flow pipe further includes:
an inflow pipe to allow the fluid, flowing from an outside to an inside of the motor, to flow; and
an outflow pipe to allow the fluid, flowing out from the inside to the outside of the motor, to flow; and
each of the inflow pipe and the outflow pipe is drawn out of the motor.
(28) The motor according to (27), wherein the inflow pipe extends in a direction intersecting the axial direction and opposes the second coil head in the axial direction.
(29) The motor according to (27) or (28), wherein the inflow pipe opposes the outflow pipe in the axial direction, and is located on one axial side with respect to the outflow pipe.
(30) The motor according to any of (27) to (29), further comprising a stator holder located on a radially inner side with respect to the stator core and including a holder cylindrical portion that holds the stator core; wherein
the stator holder is located on the other axial side with respect to the stator core, and further includes a holder plate that extends a direction intersecting the axial direction;
the holder cylindrical portion extends on axial direction from the holder plate; and
at least one of the inflow pipe and the outflow pipe is located between the stator and the holder plate, and extends in a direction intersecting the axial direction.
(31) The motor according to (30), wherein at least a portion of the flow pipe is in contact with the stator holder.
(32) The motor according to (30) or (31), wherein
one axial end of at least one of the inflow pipe and the outflow pipe is in contact with the other axial end of the stator; and
the other axial end of the at least one of the inflow pipe and the outflow pipe is in contact with one axial end of the holder plate.
(33) The motor according to any of (23) to (32), wherein the flow pipe is located on the other axial side with respect to one axial end of the first coil head.
(34) The motor according to any of (23) to (33), wherein
a plurality of the coils are arranged in the circumferential direction; and
a plurality of the at least one cooling pipe are arranged in the circumferential direction.
(35) The motor according to any of (23) to (33), wherein
a plurality of the coils are arranged in the circumferential direction; and
the at least one cooling pipe is in an annular shape surrounding the central axis.
(36) An aircraft comprising:
the motor according to any of (23) to (35); and
a tank to store a fluid to be supplied to the motor.

The example embodiments of the present disclosure have been described above. It is to be noted that the scope of the present disclosure is not limited to the above-described example embodiments. The present disclosure is implemented by adding various modifications to the above-described example embodiments within a range not departing from the spirit of the disclosure. In addition, the matters described in the above-described example embodiments can be arbitrarily combined together as appropriate within a range where no inconsistency occurs.

The present disclosure is useful for, for example, a device in which a stator generates heat in accordance with rotation of a rotor.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15: A motor comprising:
a rotor rotatable about a central axis extending in an axial direction;
a stator including a stator core having an annular shape and surrounding the central axis; and
a flow pipe allowing a fluid to flow through; wherein
the stator further includes coils located on the stator core;
the flow pipe includes connection pipes extending in the axial direction and arranged in a circumferential direction;
each of the connection pipes is located radially inward with respect to the plurality of coils and is in direct or indirect contact with the stator core;
each of the coils includes:
a first coil head located on one axial side with respect to the stator core; and
a second coil head located on another axial side with respect to the stator core; and
the flow pipe includes at least one of:
a first cooling pipe that is located on the one axial side with respect to the first coil head, opposes the first coil head in the axial direction, and extends in the circumferential direction;
a second cooling pipe that is located on the one axial side with respect to the stator core and radially inward with respect to the first coil head, opposes the first coil head in the radial direction, and extends in the circumferential direction;
a third cooling pipe that is located on the one axial side with respect to the stator core and radially outward with respect to the first coil head, opposes the first coil head in the radial direction, and extends in the circumferential direction;
a fourth cooling pipe that is located on the other axial side with respect to the second coil head, opposes the second coil head in the axial direction, and extends in the circumferential direction;
a fifth cooling pipe that is located on the other axial side with respect to the stator core and radially inward with respect to the second coil head, opposes the second coil head in the radial direction, and extends in the circumferential direction; and
a sixth cooling pipe located on the other axial side with respect to the stator core and radially outward with respect to the second coil head, opposes the second coil head in the radial direction, and extends in the circumferential direction.

16: The motor according to claim 15, wherein at least one of the connection pipes is located radially inward with respect to each of the coils.

17: The motor according to claim 15, wherein
each of the connection pipes is in contact with at least one of:
one axial side of each of the coils with respect to the stator core; and
another axial side of each of the coils with respect to the stator core.

18: The motor according to claim 15, wherein the at least one cooling pipe is in direct or indirect contact with each of the coils.

19: The motor according to claim 15, wherein
the at least one cooling pipe includes at least one of the second cooling pipe, the third cooling pipe, the fifth cooling pipe, and the sixth cooling pipe; and
the at least one cooling pipe is in direct or indirect contact with the stator core.

20: The motor according to claim 15, wherein
the coils are arranged in the circumferential direction; and
a plurality of the at least one cooling pipe are arranged in the circumferential direction.

21: The motor according to claim 15, wherein
the flow pipe further includes:
an inflow pipe to allow the fluid, flowing from an outside to an inside of the motor, to flow;
an outflow pipe to allow the fluid, flowing out from the inside to the outside of the motor, to flow; and
each of the inflow pipe and the outflow pipe is drawn out of the motor.

22: The motor according to claim 21, wherein the inflow pipe extends in a direction intersecting the axial direction, and axially opposes a portion on another axial side of each of the coils with respect to the stator core.

23: The motor according to claim 21, wherein the inflow pipe opposes the outflow pipe in the axial direction, and is located on one axial side with respect to the outflow pipe.

24: The motor according to claim 21, further comprising:
a stator holder located on a radially inner side with respect to the stator core and including a holder cylindrical portion that holds the stator core; wherein
the stator holder further includes a holder plate extending radially outward from the holder cylindrical portion; and
at least one of the inflow pipe and the outflow pipe is located between the stator and the holder plate, and extends in a direction intersecting the axial direction.

25: The motor according to claim 23, wherein
one axial end of at least one of the inflow pipe and the outflow pipe is in contact with another axial end of the stator; and
another axial end of the at least one of the inflow pipe and the outflow pipe is in contact with one axial end of the holder plate.

26: The motor according to claim 15, wherein the flow pipe is located on another axial side with respect to one axial end of the first coil head.

27: An aircraft comprising:
the motor according to claim 15; and
a tank to store a fluid to be supplied to the motor.
